(19) United States
(12) Patent Application Publication
(10) Pub. No.: US 2026/0097366 A1
(43) Pub. Date: Apr. 9, 2026

(54) VARYING MICROPOROUS CONSTRUCTS FOR BIPOLAR MEMBRANES IN BIPOLAR MEMBRANE ELECTRODIALYSIS

(71) Applicant: W. L. Gore & Associates, Inc., Newark, DE (US)

(72) Inventors: John P. Hennessey, Philadelphia, PA (US); Rukmini B. Lobo, Lincoln University, PA (US); Varendra N. Silva, Flagstaff, AZ (US); John E. Trouba, Avondale, PA (US); Holly R. Thompson, Newark, DE (US)

(21) Appl. No.: 19/406,255

(22) Filed: Dec. 2, 2025

Related U.S. Application Data
(63) Continuation-in-part of application No. 19/283,586, filed on Jul. 29, 2025, now abandoned.
(60) Provisional application No. 63/677,253, filed on Jul. 30, 2024.
(60) Provisional application No. 63/852,279, filed on Jul. 28, 2025.

(51) Int. Cl. B01D 61/44; B01D 69/02; B01D 69/12; B01D 69/14

(52) U.S. Cl. CPC B01D 61/445; B01D 69/02; B01D 69/12; B01D 69/145; B01D 2325/0283; B01D 2325/02834; B01D 2325/04; B01D 2325/42

(57) ABSTRACT

A bipolar membrane composite including a first membrane, a second membrane, an optional additional membrane, a first ion exchange material, a second ion exchange material, and a catalyst. The bipolar membrane composite being configured to create an acidic solution and a basic solution when exposed to a main flow of fluid and an external current supply.

### CROSS-REFERENCE TO RELATED APPLICATION

This application is a continuation-in-part of U.S. application No. Ser. No. 19/283,586, filed Jul. 29, 2025, which claims the benefit of Provisional Application No. 63/677,253, filed Jul. 30, 2024, and also claims the benefit of Provisional Application No. 63/852,279, filed Jul. 28, 2025, which are incorporated herein by reference in their entireties for all purposes.

### FIELD

The present disclosure relates to bipolar membrane composites including an anion exchange reinforcement membrane and cation exchange reinforcement membrane joined together, facing each other and has a function for dissociating water into protons and hydroxide ions. The bipolar membrane composite may be configured in an electro-dialyzing apparatus to create an acidic solution and a basic solution from a salt solution.

### BACKGROUND

Bipolar membrane composites may be employed in applications such as bipolar membrane electrodialysis. Bipolar membrane composites may be designed to dissociate water molecules into protons and hydroxide ions and separate the resulting ions within a solution to create an acidic solution and a basic solution. These bipolar membranes include semipermeable anion exchange layers and cation exchange layers which include ion exchange material, such as ionomers.

Applications of bipolar membrane composites in bipolar membrane electrodialysis may include carbon capture carbon dioxide removal (CDR) carbon dioxide reduction, sodium sulfate remediation, metal recovery, and reduction of N₂ to ammonia. The reduction and removal of carbon dioxide from the atmosphere has become a global concern. Removal of CO₂ from the atmosphere using carbonate-based chemical reactions may utilize bipolar membrane composites. However, existing bipolar membrane composite technology may not enable efficient and effective CDR with favorable techno-economic feasibility.

The bipolar membrane composites disclosed herein provide favorable techno-economics as optimization of membrane microstructure, membrane layer composition, and membrane thickness can enable fast water kinetics, high water dissociation rates, high ion exchange rates and low undesired ion crossover which can enable bipolar membrane electrodialysis to operate at high current densities with low performance degradation.

### SUMMARY

Disclosed are bipolar membrane composites and methods of making bipolar membrane composites configured to separate a solution into an acidic solution and a basic solution.

According to one embodiment (Embodiment 1), the disclosure relates to a bipolar membrane composite that generates an acidic solution and a basic solution when the membrane composite is exposed to water and an electric current by enabling an oxidation-reduction reaction that dissociates water into a proton component and a hydroxide ion component with each component disposed on opposing sides of the bipolar membrane composite. The bipolar membrane composite includes an anion exchange layer including an anion exchange layer (AEL) reinforcement membrane having an open structure, defining a plurality of pores having an average pore size of 0.2 μm to 5.0 μm; a cation exchange layer including a cation exchange layer (CEL) reinforcement membrane having an open structure, defining a plurality of pores having an average pore size of 0.2 μm to 5.0 μm; a first ion exchange material at least partially embedded within the AEL reinforcement membrane; a second ion exchange material at least partially embedded within the CEL reinforcement membrane; and a water dissociation catalyst at least partially embedded within at least one of the AEL and CEL reinforcement membranes such that the water dissociation catalyst is embedded extending from the interface into less than 10% of a thickness of the at least one of the AEL and CEL reinforcement membranes. The AEL engages the CEL at an interface to form the bipolar membrane composite.

Embodiment 2 is a bipolar membrane composite that generates an acidic solution and a basic solution when the membrane composite is exposed to water and an electric current by enabling an oxidation-reduction reaction that dissociates water into a proton component and a hydroxide ion component with each component disposed on opposing sides of the bipolar membrane composite. The bipolar membrane composite includes an anion exchange layer including an anion exchange layer (AEL) reinforcement membrane having an open structure and an opposing tight structure, the AEL reinforcement membrane open structure defining a plurality of pores having an average pore size of 0.2 μm to 5.0 μm, the AEL reinforcement membrane tight structure defining a plurality of pores having an average pore size of 0.02 μm to 1.0 μm; a cation exchange layer including an cation exchange layer (CEL) reinforcement membrane having an open structure and an opposing tight structure, the CEL reinforcement membrane open structure defining a plurality of pores having an average pore size of 0.2 μm to 5.0 μm, the CEL reinforcement membrane tight structure defining a plurality of pores having an average pore size of 0.02 μm to 1.0 μm; a first ion exchange material at least partially embedded within at least one of the AEL reinforcement membrane open structure and the AEL reinforcement membrane tight structure; a second ion exchange material at least partially embedded within at least one of the CEL reinforcement membrane open structure and the CEL reinforcement membrane tight structure; and a water dissociation catalyst at least partially embedded within at least one of the AEL reinforcement membrane tight structure and the CEL reinforcement membrane tight structure. The AEL tight structure engages the CEL tight structure to form the bipolar membrane composite.

Embodiment 3 is the bipolar membrane composite of Embodiment 2, wherein the bipolar membrane composite defines a bipolar membrane composite thickness extending inclusively between opposing sides of the bipolar membrane composite. At least one of the AEL reinforcement membrane open structure, the AEL reinforcement membrane tight structure, the CEL reinforcement membrane open structure, and the CEL reinforcement membrane tight structure extends into the membrane by at least 30% of the bipolar membrane composite thickness.

Embodiment 4 is the bipolar membrane composite of Embodiments 2 or 3, wherein the AEL reinforcement membrane tight structure and CEL reinforcement membrane tight structure have identical pore characteristics.

Embodiment 5 is the bipolar membrane composite of Embodiments 2 to 4, wherein the AEL reinforcement membrane tight structure and CEL reinforcement membrane tight structure have different pore characteristics.

Embodiment 6 is a bipolar membrane composite that generates an acidic solution and a basic solution when the membrane composite is exposed to water and an electric current by enabling an oxidation-reduction reaction that dissociates water into a proton component and a hydroxide ion component with each component disposed on opposing sides of the bipolar membrane composite. The bipolar membrane composite includes an anion exchange layer including an AEL reinforcement membrane having an open structure, defining a plurality of pores having an average pore size of 0.2 μm to 5.0 μm; a cation exchange layer including an CEL reinforcement membrane having an open structure, defining a plurality of pores having an average pore size of 0.2 μm to 5.0 μm; an AEL reinforcement membrane having a first ion exchange material at least partially embedded within the AEL reinforcement membrane; a CEL reinforcement membrane having a second ion exchange material at least partially embedded within the CEL reinforcement membrane; and an additional membrane including a water dissociation catalyst at least partially embedded within the additional membrane. The additional membrane is disposed between the AEL and CEL to form the bipolar membrane composite.

Embodiment 7 is the bipolar membrane composite of Embodiment 6, wherein the additional membrane is a microporous membrane defined by a tight structure having an average pore size of 0.02 μm to 1.0 μm.

Embodiment 8 is the bipolar membrane composite of Embodiment 6, wherein the additional membrane is a catalyst filled membrane.

Embodiment 9 is the bipolar membrane composite of Embodiments 6 to 8, wherein the additional membrane is at least one of a fluorinated polymer, a non-fluorinated polymer, polyethylene (PE), expanded polyethylene (ePE), polytetrafluoroethylene (PTFE), poly(ethylene-co-tetrafluoroethylene) (ETFE), expanded polytetrafluoroethylene (ePTFE), polyvinylidene fluoride (PVDF), expanded polyvinylidene fluoride (ePVDF), expanded poly(ethylene-co-tetrafluoroethylene) (eETFE), polyetheretherketone (PEEK), and mixtures thereof.

Embodiment 10 is the bipolar membrane composite of Embodiments 6 to 9, wherein at least one of the first ion exchange material and the second ion exchange material is at least partially embedded into the additional membrane.

Embodiment 11 is the bipolar membrane composite of Embodiments 6 to 10, wherein the additional membrane is supported by at least one of a film, a tape, the AEL, the CEL, and another membrane.

Embodiment 12 is a bipolar membrane composite that generates an acidic solution and a basic solution when the membrane composite is exposed to water and an electric current by enabling an oxidation-reduction reaction that dissociates water into a proton component and a hydroxide ion component with each component disposed on opposing sides of the bipolar membrane composite. The bipolar membrane composite includes an anion exchange layer including an AEL reinforcement membrane having an open structure and an opposing tight structure, the AEL reinforcement membrane open structure defining a plurality of pores having an average pore size of 0.2 μm to 5.0 μm, the AEL reinforcement membrane tight structure defining a plurality of pores having an average pore size of 0.02 μm to 1.0 μm; a cation exchange layer including an CEL reinforcement membrane having an open structure defining a plurality of pores having an average pore size of 0.2 μm to 5.0 μm; a first ion exchange material at least partially embedded within at least one of the AEL reinforcement membrane open structure and the AEL reinforcement membrane tight structure; a second ion exchange material at least partially embedded within the CEL reinforcement membrane; and a water dissociation catalyst at least partially embedded within at least one of the AEL reinforcement membrane tight structure and the CEL reinforcement membrane open structure. The AEL tight structure engages the CEL open structure to form the bipolar membrane composite.

Embodiment 13 is the bipolar membrane composite of Embodiment 12, wherein the bipolar membrane composite defines a bipolar membrane thickness extending inclusively between opposing sides of the bipolar membrane composite, at least one of the AEL reinforcement membrane open structure, the AEL reinforcement membrane tight structure, and the CEL reinforcement membrane open structure extends into the membrane by at least 30% of the bipolar membrane composite thickness.

Embodiment 14 is the bipolar membrane composite of Embodiments 1 to 13, wherein the AEL reinforcement membrane open structure and the CEL reinforcement membrane open structure have identical pore characteristics.

Embodiment 15 is the bipolar membrane composite of Embodiments 1 to 14, wherein the AEL reinforcement membrane open structure and the CEL reinforcement membrane open structure have different pore characteristics.

Embodiment 16 is the bipolar membrane composite of Embodiments 1 to 15, wherein the engagement of the AEL and CEL reinforcement membranes to form the bipolar membrane composite is at least one of a layered, melted, glued, mechanically compressed, laminated, and paste processed.

Embodiment 17 is the bipolar membrane composite of Embodiments 1 to 16, wherein a concentration of the first ion exchange material varies across the AEL reinforcement membrane such that the ion exchange material concentration increases between a first end and an opposing second end of the AEL reinforcement membrane.

Embodiment 18 is the bipolar membrane composite of Embodiments 1 to 17, where a concentration of the second ion exchange material varies across the CEL reinforcement membrane such that the ion exchange material concentration increases between a first end and an opposing second end of the CEL reinforcement membrane.

Embodiment 19 is the bipolar membrane composite of Embodiments 1 to 18, wherein each of the AEL reinforcement membrane and the CEL reinforcement membrane has an embedded thickness inclusively ranging from 1 μm to 100 μm; a ratio of a thickness of the AEL reinforcement membrane open structure to a thickness of the AEL reinforcement membrane tight structure is from 0.5 to 100; and a ratio of a thickness of the CEL reinforcement membrane open structure to a thickness of the CEL reinforcement membrane tight structure is from 0.5 to 100.

Embodiment 20 is the bipolar membrane composite of Embodiments 1 to 19, wherein each of the AEL reinforcement membrane and CEL reinforcement membrane includes a microporous polymer structure.

Embodiment 21 is the bipolar membrane composite of Embodiments 1 to 20, wherein each of the AEL and CEL reinforcement membranes is at least one of a fluorinated polymer, a non-fluorinated polymer, polyethylene (PE), expanded polyethylene (ePE), polytetrafluoroethylene (PTFE), poly(ethylene-co-tetrafluoroethylene) (ETFE), expanded polytetrafluoroethylene (ePTFE), polyvinylidene fluoride (PVDF), expanded polyvinylidene fluoride (ePVDF), expanded poly(ethylene-co-tetrafluoroethylene) (eETFE), polyetheretherketone (PEEK), and mixtures thereof.

Embodiment 22 is the bipolar membrane composite of Embodiments 1 to 21, wherein the AEL and the CEL may be engaged such that there is a discernable interface with a measurable thickness between the AEL and the CEL.

Embodiment 23 is the bipolar membrane composite of Embodiments 1 to 22, wherein the AEL and the CEL may be engaged such that there is not a discernable interface with a measurable thickness between the AEL and the CEL.

Embodiment 24 is a bipolar membrane composite that generates an acidic solution and a basic solution when the membrane composite is exposed to water and an electric current by enabling an oxidation-reduction reaction that dissociates water into a proton component and a hydroxide ion component with each ion disposed on opposing sides of the bipolar membrane composite. The bipolar membrane composite includes a single reinforcement membrane having a first open structure, an opposing second open structure, and a tight structure between the first open structure and the second open structure; a first ion exchange material at least partially embedded within the first open structure; a second ion exchange material at least partially embedded within the second open structure; and a water dissociation catalyst at least partially embedded within the tight structure. The open structure defines a plurality of pores having an average pore size of 0.2 μm to 5.0 μm, and the tight structure defining a plurality of pores having an average pore size of 0.2 μm to 1.0 μm.

Embodiment 25 is the bipolar membrane composite of Embodiment 24, wherein at least one of the first ion exchange material and the second ion exchange material is at least partially embedded within the tight structure.

Embodiment 26 is the bipolar membrane composite of Embodiments 24 to 25, wherein the single membrane includes a microporous polymer structure.

Embodiment 27 is the bipolar membrane composite of Embodiments 24 to 26, wherein the single membrane is at least one of a fluorinated polymer, a non-fluorinated polymer, polyethylene (PE), expanded polyethylene (ePE), polytetrafluoroethylene (PTFE), poly(ethylene-co-tetrafluoroethylene) (ETFE), expanded polytetrafluoroethylene (ePTFE), polyvinylidene fluoride (PVDF), expanded polyvinylidene fluoride (ePVDF), expanded poly(ethylene-co-tetrafluoroethylene) (eETFE), polyetheretherketone (PEEK), and mixtures thereof.

Embodiment 28 is the bipolar membrane composite of Embodiments 24 to 27, wherein the first open structure and the second open structure have different pore characteristics.

Embodiment 29 is the bipolar membrane composite of Embodiments 24 to 27, wherein the first open structure and the second open structure have the identical pore characteristics.

Embodiment 30 is the bipolar membrane composite of Embodiments 24 to 29, wherein the bipolar membrane composite defines a bipolar membrane composite thickness extending inclusively between opposing sides of the bipolar membrane composite, at least one of the first open structure, the second open structure, and the tight structure extends into the singular membrane by at least 30% of the bipolar membrane thickness.

Embodiment 31 is the bipolar membrane composite of Embodiments 1 to 30, wherein the water contains an electrolyte.

Embodiment 32 is the bipolar membrane composite of Embodiments 1 to 31, wherein the water contains a salt.

Embodiment 33 is the bipolar membrane composite of Embodiments 1 to 32, wherein the water includes seawater.

Embodiment 34 is the bipolar membrane composite of Embodiments 1 to 33, wherein the first ion exchange material includes a cation exchange material, and the second ion exchange material includes an anion exchange material.

Embodiment 35 is the bipolar membrane composite of Embodiments 1 to 34, wherein the acidic solution and basic solution are suitable for use with subsequent processing of carbon dioxide and carbonates.

Embodiment 36 is a method of creating an acidic flow and a basic flow from a main flow of water. The method includes applying an electric current to a bipolar membrane composite in an electrochemical apparatus; hydrating the bipolar membrane composite with water; dissociating the water at the water dissociation catalyst; and separating the protons into a first flow and the hydroxide ions into a second flow, the first flow disposed proximate to a first side of the bipolar membrane composite facing the first flow, the second flow disposed proximate to an opposing second side of the bipolar membrane composite facing the second flow. The bipolar membrane composite includes an anion exchange layer including an AEL reinforcement membrane having an open structure, defining a plurality of pores having an average pore size of 0.2 μm to 5.0 μm; a cation exchange layer including an CEL reinforcement membrane having an open structure, defining a plurality of pores having an average pore size of 0.2 μm to 5.0 μm; a first ion exchange material at least partially embedded within the AEL reinforcement membrane open structure; a second ion exchange material at least partially embedded within the CEL reinforcement membrane open structure; and a water dissociation catalyst at least partially embedded within at least one of the AEL and CEL reinforcement membranes such that the water dissociation catalyst is embedded extending from the interface into less than 10% of a thickness of the at least one of the AEL and CEL reinforcement membranes. The AEL engages the CEL at an interface to form the bipolar membrane composite. The CEL faces the first flow and the AEL faces the second flow. The first flow includes the acidic flow and the second flow includes the basic flow.

Embodiment 37 is the method of Embodiment 36, wherein the AEL reinforcement membrane further includes a tight structure defining a plurality of pores having an average pore size of 0.02 μm to 1 μm.

Embodiment 38 is the method of Embodiment 37, wherein the water dissociation catalyst is at least partially embedded within the AEL reinforcement membrane tight structure.

Embodiment 39 is a method of creating an acidic flow and a basic flow from a main flow of water. The method includes applying an electric current to a bipolar membrane composite in an electrochemical apparatus; hydrating the bipolar membrane composite with water; dissociating water at the water dissociation catalyst; and separating the protons into a first flow and hydroxide ions into a second flow, the first flow disposed proximate to a first side of the bipolar membrane composite facing the first flow, the second flow disposed proximate to an opposing second side of the bipolar membrane composite facing the second flow. The bipolar membrane composite includes an anion exchange layer including an AEL reinforcement membrane having an open structure and an opposing tight structure, the AEL reinforcement membrane open structure defining a plurality of pores having an average pore size of 0.2 μm to 5.0 μm, the AEL reinforcement membrane tight structure defining a plurality of pores having an average pore size of 0.02 μm to 1.0 μm; a cation exchange layer including an CEL reinforcement membrane having an open structure and an opposing tight structure, the CEL reinforcement membrane open structure defining a plurality of pores having an average pore size of 0.2 μm to 5.0 μm, the CEL reinforcement membrane tight structure defining a plurality of pores having an average pore size of 0.02 μm to 1.0 μm; a first ion exchange material at least partially embedded within at least one of the AEL reinforcement membrane open structure and the AEL reinforcement membrane tight structure; a second ion exchange material at least partially embedded within at least one of the CEL reinforcement membrane open structure and the CEL reinforcement membrane tight structure; and a water dissociation catalyst at least partially embedded within at least one of the AEL reinforcement membrane tight structure and the CEL reinforcement membrane tight structure. The AEL tight structure engages the CEL tight structure to form the bipolar membrane composite. The CEL faces the first flow and the AEL faces the second flow. The first flow includes the acidic flow and the second flow includes the basic flow.

Embodiment 40 is a method of creating an acidic flow and a basic flow from a main flow of water. The method includes applying an electric current to a bipolar membrane composite in an electrochemical apparatus; hydrating the bipolar membrane composite with water; dissociating water at the water dissociation catalyst; and separating the protons into a first flow and hydroxide ions into a second flow, the first flow disposed proximate to a first side of the bipolar membrane composite facing the first flow, the second flow disposed proximate to an opposing second side of the bipolar membrane composite facing the second flow. The bipolar membrane composite includes an anion exchange layer including an AEL reinforcement membrane; a cation exchange layer including a CEL reinforcement membrane; and an additional membrane, the additional membrane including a water dissociation catalyst at least partially embedded within the additional membrane. The additional membrane is disposed between the AEL and the CEL to form the bipolar membrane composite. The CEL faces the first flow and the AEL faces the second flow. The first flow includes the acidic flow and the second flow includes the basic flow.

Embodiment 41 is the method of Embodiment 40, wherein the AEL reinforcement membrane further including an open structure, defining a plurality of pores having an average pore size of 0.2 μm to 5.0 μm; the CEL reinforcement membrane further including an open structure defining a plurality of pores having an average pore size of 0.2 μm to 5.0 μm; a first ion exchange material at least partially embedded within the AEL reinforcement membrane open structure; and a second ion exchange material at least partially embedded within the CEL reinforcement membrane open structure.

Embodiment 42 is the method of Embodiments 40 to 41, wherein the additional membrane is a catalyst filled membrane.

Embodiment 43 is the method of Embodiments 40 to 41, wherein the additional membrane includes a tight structure defining a plurality of pores having an average pore size of 0.02 μm to 1.0 μm.

Embodiment 44 is the method of Embodiments 40 to 43, wherein the additional membrane contains an ion exchange material or ionomer.

Embodiment 45 is a method of creating an acidic flow and a basic flow from a main flow of water. The method includes applying an electric current to a bipolar membrane composite in an electrochemical apparatus; hydrating the bipolar membrane composite with water; dissociating water at the water dissociation catalyst; and separating the protons into a first flow and hydroxide ions into a second flow, the first flow disposed proximate to a first side of the bipolar membrane composite facing the first flow, the second flow disposed proximate to an opposing second side of the bipolar membrane composite facing the second flow. The bipolar membrane composite includes a single membrane having a first open structure, an opposing second open structure, and a tight structure between first open structure and the second open structure; a first ion exchange material at least partially embedded within the first open structure; a second ion exchange material at least partially embedded within the second open structure; and a water dissociation catalyst at least partially embedded within the tight structure. The open structure defining a plurality of pores having an average pore size of 0.2 μm to 5.0 μm, and the tight structure defining a plurality of pores having an average pore size of 0.2 μm to 1.0 μm. The first flow includes the acidic flow and the second flow includes the basic flow.

Embodiment 46 is an electrodialysis system including the bipolar membrane composite of at least one of Embodiments 1, 2, 6, 12, and 24; a fluid; a first electrode, the first electrode including an anode; and a second electrode, the second electrode including a cathode.

Embodiment 47 is the electrodialysis system of Embodiment 46, wherein the fluid is salt water.

Embodiment 48 is the electrodialysis system of Embodiment 46, wherein the fluid is sea water.

Embodiment 49 is the electrodialysis system of Embodiment 46, wherein the fluid contains an electrolyte.

Embodiment 50 is a bipolar membrane composite that generates an acidic solution and a basic solution when the membrane composite is exposed to water and an electric current by enabling an oxidation-reduction reaction that dissociates water into a proton component and a hydroxide ion component with each component disposed on opposing sides of the bipolar membrane composite, the bipolar membrane composite including:
an anion exchange layer (AEL) including an anion exchange polymer and optionally an AEL reinforcement layer at least partially embedded within the anion exchange polymer;
a cation exchange layer (CEL) including a cation exchange polymer and optionally a CEL reinforcement layer at least partially embedded within the cation exchange polymer;
wherein at least one of the AEL or CEL has a reinforcement layer having an open structure, defining a plurality of pores having an average pore size of 0.2 μm to 5.0 μm;
a water dissociation catalyst at least partially embedded within at least one of the AEL or CEL such that the water dissociation catalyst is embedded extending from an interface between the AEL and CEL into less than 10% of a thickness of the at least one of the AEL or CEL.

Embodiment 51 is a bipolar membrane composite that generates an acidic solution and a basic solution when the membrane is exposed to water and an electric current by enabling an oxidation-reduction reaction that dissociates water into a proton component and a hydroxide ion component with each component disposed on opposing sides of the bipolar membrane composite, the bipolar membrane composite including:
an anion exchange layer (AEL) including an anion exchange polymer and optionally a AEL reinforcement layer at least partially embedded within the anion exchange polymer;
a cation exchange layer (CEL) including a cation exchange polymer and optionally a CEL reinforcement layer at least partially embedded within the cation exchange polymer;
wherein at least one of the AEL or CEL has a reinforcement layer having an open structure and an opposing tight structure, wherein the AEL or CEL open structure defining a plurality of pores having an average pore size of 0.2 μm to 5.0 μm, and the AEL or CEL tight structure defining a plurality of pores having an average pore size of 0.02 μm to 1.0 μm; and
a water dissociation catalyst at least partially embedded within at least one of the AEL tight structure and the CEL tight structure, such that the water dissociation catalyst is embedded extending from an interface between the AEL tight structure and CEL tight structure.

Embodiment 52 is bipolar membrane composite of Embodiment 51, wherein the bipolar membrane composite defines a bipolar membrane composite thickness extending inclusively between opposing sides of the bipolar membrane composite, at least one of the AEL open structure, the AEL tight structure, the CEL open structure, and the CEL tight structure extends into the membrane by at least 30% of the bipolar membrane thickness.

Embodiment 53 is the bipolar membrane composite of Embodiment 51 or 52, wherein the AEL tight structure and CEL tight structure have identical pore characteristics.

Embodiment 54 is the bipolar membrane composite of any one of Embodiments 51 to 53, wherein the AEL tight structure and CEL tight structure have different pore characteristics.

Embodiment 55 is a bipolar membrane composite that generates an acidic solution and a basic solution when the membrane is exposed to water and an electric current by enabling an oxidation-reduction reaction that dissociates water into a proton component and a hydroxide ion component with each component disposed on opposing sides of the bipolar membrane composite, the bipolar membrane composite including:
an anion exchange layer (AEL) including an anion exchange polymer and optionally a AEL reinforcement layer at least partially embedded within the anion exchange polymer;
a cation exchange layer (CEL) including a cation exchange polymer and optionally a CEL reinforcement layer at least partially embedded within the cation exchange polymer;
wherein at least one of the AEL or CEL has a reinforcement layer having an open structure, defining a plurality of pores having an average pore size of 0.2 μm to 5.0 μm;
an additional membrane including a water dissociation catalyst at least partially embedded within the additional membrane, such that the water dissociation catalyst is embedded extending from an interface between the AEL and CEL.

Embodiment 56 is the bipolar membrane composite of Embodiment 55, wherein the additional membrane is a microporous membrane defined by a tight structure having an average pore size of 0.02 μm to 1.0 μm.

Embodiment 57 is the bipolar membrane composite of Embodiment 55 or 56, wherein the additional membrane is a catalyst filled membrane.

Embodiment 58 is the bipolar membrane composite of one of Embodiments 55 to 57, wherein the additional membrane is at least one of a fluorinated polymer, a non-fluorinated polymer, polyethylene (PE), expanded polyethylene (ePE), polytetrafluoroethylene (PTFE), poly(ethylene-co-tetrafluoroethylene) (ETFE), expanded polytetrafluoroethylene (ePTFE), polyvinylidene fluoride (PVDF), expanded polyvinylidene fluoride (ePVDF), expanded poly(ethylene-co-tetrafluoroethylene) (eETFE), polyetheretherketone (PEEK), and mixtures thereof.

Embodiment 59 is the bipolar membrane composite of any one of Embodiments 55 to 58, wherein at least one of the anion exchange polymer and the anion exchange polymer is at least partially embedded into the additional membrane.

Embodiment 60 is the bipolar membrane composite of any one of Embodiments 55 to 59, wherein the additional membrane is supported by at least one of a film, a tape, the first membrane, the second membrane, and another membrane.

Embodiment 61 is a bipolar membrane composite that generates an acidic solution and a basic solution when the membrane is exposed to water and an electric current by enabling an oxidation-reduction reaction that dissociates water into a proton component and a hydroxide ion component with each component disposed on opposing sides of the bipolar membrane composite, the bipolar membrane composite including:
an anion exchange layer (AEL) including an anion exchange polymer and optionally a AEL reinforcement layer at least partially embedded within the anion exchange polymer;
   wherein the AEL has a reinforcement layer having an open structure and an opposing tight structure, wherein the AEL open structure defining a plurality of pores having an average pore size of 0.2 μm to 5.0 μm, and the AEL tight structure defining a plurality of pores having an average pore size of 0.02 μm to 1.0 μm;
a cation exchange layer (CEL) including a cation exchange polymer and optionally a CEL reinforcement layer at least partially embedded within the cation exchange polymer;
wherein the CEL has a reinforcement layer having an open structure, defining a plurality of pores having an average pore size of 0.2 μm to 5.0 μm; and
a water dissociation catalyst at least partially embedded within at least one of the AEL tight structure and the CEL open structure, such that the water dissociation catalyst is embedded extending from an interface between the AEL tight structure and the CEL open structure.

Embodiment 62 is the bipolar membrane composite of Embodiment 61, wherein the bipolar membrane composite defines a bipolar membrane composite thickness extending inclusively between opposing sides of the bipolar membrane composite, at least one of the AEL open structure, the AEL tight structure, and the CEL open structure extends into the membrane by at least 30% of the bipolar membrane composite thickness.

Embodiment 63 is the bipolar membrane composite of any one of the preceding Embodiments, wherein the AEL open structure and the CEL open structure have identical pore characteristics.

Embodiment 64 is the bipolar membrane composite of any one of the preceding Embodiments, wherein the AEL open structure and the CEL open structure have different pore characteristics.

Embodiment 65 is the bipolar membrane composite of any one of the preceding Embodiments, wherein the engagement of the AEL and CEL to form the bipolar membrane composite is at least one of a layered, melted, glued, mechanically compressed, laminated, and paste processed.

Embodiment 66 is the bipolar membrane composite of any one of the preceding Embodiments, wherein a concentration of the anion exchange polymer varies across the AEL such that the anion exchange polymer concentration increases between a first end and an opposing second ends of the AEL.

Embodiment 67 is the bipolar membrane composite of any one of the preceding Embodiments, where a concentration of the cation exchange polymer varies across the CEL such that the cation exchange polymer concentration increases between a first end and an opposing second ends of the CEL.

Embodiment 68 is the bipolar membrane composite of any one of the preceding Embodiments, wherein each of the AEL and the CEL has an embedded thickness inclusively ranging from 1 μm to 100 μm;
wherein a ratio of a thickness of the AEL open structure to a thickness of the AEL tight structure is from 0.5 to 100; and
   wherein a ratio of a thickness of the CEL open structure to a thickness of the CEL tight structure is from 0.5 to 100.

Embodiment 69 is the bipolar membrane composite of any one of the preceding claims, wherein each of the AEL and CEL include a microporous polymer structure.

Embodiment 70 is the bipolar membrane composite of any one of the preceding Embodiments, wherein each of the AEL and CEL is at least one of a fluorinated polymer, a non-fluorinated polymer, polyethylene (PE), expanded polyethylene (ePE), polytetrafluoroethylene (PTFE), poly(ethylene-co-tetrafluoroethylene) (ETFE), expanded polytetrafluoroethylene (ePTFE), polyvinylidene fluoride (PVDF), expanded polyvinylidene fluoride (ePVDF), expanded poly(ethylene-co-tetrafluoroethylene) (eETFE), polyetheretherketone (PEEK), and mixtures thereof.

Embodiment 71 is the bipolar membrane composite of any one of the preceding Embodiments, wherein the AEL and the CEL may be engaged such that there is a discernable interface with a measurable thickness between the AEL and the CEL.

Embodiment 72 is the bipolar membrane composite of any one of the preceding Embodiments, wherein the AEL and the CEL may be engaged such that there is not a discernable interface with a measurable thickness between the AEL and the CEL.

Embodiment 73 is a bipolar membrane composite that generates an acidic solution and a basic solution when the membrane is exposed to water and an electric current by enabling an oxidation-reduction reaction that dissociates water into a proton component and a hydroxide ion component with each ion disposed on opposing sides of the bipolar membrane composite, the bipolar membrane composite including:
a single membrane having a first open structure, an opposing second open structure, and a tight structure between the first open structure and the second open structure;
wherein the open structure defining a plurality of pores having an average pore size of 0.2 μm to 5.0 μm, and the tight structure defining a plurality of pores having an average pore size of 0.2 μm to 1.0 μm;
an anion exchange polymer at least partially embedded within the first open structure;
a cation exchange polymer at least partially embedded within the second open structure; and
a water dissociation catalyst at least partially embedded within the tight structure.

Embodiment 74 is the bipolar membrane composite of embodiment 73, wherein at least one of the anion exchange polymer and the anion exchange polymer is at least partially embedded within the tight structure.

Embodiment 75 is the bipolar membrane composite of Embodiment 73 or 74, wherein the single membrane includes a microporous polymer structure.

Embodiment 76 is the bipolar membrane composite of any one of Embodiments 73 to 75, wherein the single membrane is at least one of a fluorinated polymer, a non-fluorinated polymer, polyethylene (PE), expanded polyethylene (ePE), polytetrafluoroethylene (PTFE), poly(ethylene-co-tetrafluoroethylene) (ETFE), expanded polytetrafluoroethylene (ePTFE), polyvinylidene fluoride (PVDF), expanded polyvinylidene fluoride (ePVDF), expanded poly(ethylene-co-tetrafluoroethylene) (eETFE), polyetheretherketone (PEEK), and mixtures thereof.

Embodiment 77 is the bipolar membrane composite of any one of Embodiments 73 to 76, wherein the first open structure and the second open structure have different pore characteristics.

Embodiment 78 is the bipolar membrane composite of any one of Embodiments 73 to 77, wherein the first open structure and the second open structure have the identical pore characteristics.

Embodiment 79 is the bipolar membrane composite of any one of Embodiments 73 to 78, wherein the bipolar membrane composite defines a bipolar membrane composite thickness extending inclusively between opposing sides of the bipolar membrane composite, at least one of the first open structure, the second open structure, and the tight structure extends into the singular membrane by at least 30% of the bipolar membrane composite thickness.

Embodiment 80 is the bipolar membrane composite of any one of the preceding Embodiments, wherein the water contains an electrolyte.

Embodiment 81 is the bipolar membrane composite of any one of the preceding Embodiments, wherein the water contains a salt.

Embodiment 82 is the bipolar membrane composite of any one of the preceding Embodiments, wherein the water includes seawater.

Embodiment 83 is the bipolar membrane composite of any one of the preceding Embodiments, wherein the acidic solution and basic solution are suitable for use with subsequent processing of carbon dioxide and carbonates.

Embodiment 84 is a method of creating an acidic flow and a basic flow from a main flow of water, the method including:
applying an electric current to a bipolar membrane composite in an electrochemical apparatus;
wherein the bipolar membrane composite includes:
   an anion exchange layer (AEL) including an anion exchange polymer and optionally a AEL reinforcement layer at least partially embedded within the anion exchange polymer;
   a cation exchange layer (CEL) including a cation exchange polymer and optionally a CEL reinforcement layer at least partially embedded within the cation exchange polymer;
      wherein at least one of the AEL or CEL has a reinforcement layer having an open structure, defining a plurality of pores having an average pore size of 0.2 μm to 5.0 μm;
   a water dissociation catalyst at least partially embedded within at least one of the AEL or CEL such that the water dissociation catalyst is embedded extending from an interface between the AEL and CEL into less than 10% of a thickness of the at least one of the AEL or CEL;
hydrating the bipolar membrane composite with water
dissociating water at the water dissociation catalyst; and
separating the protons into a first flow and hydroxide ions into a second flow, the first flow disposed proximate to a first side of the bipolar membrane composite facing the first flow, the second flow disposed proximate to an opposing second side of the bipolar membrane composite facing the second flow;
   wherein the CEL faces the first flow and the AEL faces the second flow;
   wherein the first flow includes the acidic flow and the second flow includes the basic flow.

Embodiment 85 is the method of Embodiment 84, wherein the AEL further includes a tight structure defining a plurality of pores having an average pore size of 0.02 μm to 1 μm.

Embodiment 86 is the method of claim 85, wherein the water dissociation catalyst is at least partially embedded within the AEL tight structure.

Embodiment 87 is a method of creating an acidic flow and a basic flow from a main flow of water, the method including:
applying an electric current to a bipolar membrane composite in an electrochemical apparatus;
wherein the bipolar membrane composite includes:
   an anion exchange layer (AEL) including an anion exchange polymer and optionally a AEL reinforcement layer at least partially embedded within the anion exchange polymer;
   a cation exchange layer (CEL) including a cation exchange polymer and optionally a CEL reinforcement layer at least partially embedded within the cation exchange polymer;
      wherein at least one of the AEL or CEL has a reinforcement layer having an open structure and an opposing tight structure, wherein the AEL or CEL open structure defining a plurality of pores having an average pore size of 0.2 μm to 5.0 μm, and the AEL or CEL tight structure defining a plurality of pores having an average pore size of 0.02 μm to 1.0 μm; and
   a water dissociation catalyst at least partially embedded within at least one of the AEL tight structure and the CEL tight structure, such that the water dissociation catalyst is embedded extending from an interface between the AEL tight structure and CEL tight structure.
hydrating the bipolar membrane composite with water;
dissociating water at the water dissociation catalyst; and
separating the protons into a first flow and hydroxide ions into a second flow, the first flow disposed proximate to a first side of the bipolar membrane composite facing the first flow, the second flow disposed proximate to an opposing second side of the bipolar membrane composite facing the second flow;
   wherein the CEL faces the first flow and the AEL faces the second flow;
   wherein the first flow includes the acidic flow and the second flow includes the basic flow.

Embodiment 88 is a method of creating an acidic flow and a basic flow from a main flow of water, the method including:
applying an electric current to a bipolar membrane composite in an electrochemical apparatus;
wherein the bipolar membrane composite includes:
   an anion exchange layer (AEL);
   a cation exchange layer (CEL); and
   an additional membrane, the additional membrane including a water dissociation catalyst at least partially embedded within the additional membrane, such that the water dissociation catalyst is embedded
extending from an interface between the AEL and CEL; hydrating the bipolar membrane composite with water; dissociating water at the water dissociation catalyst; and
separating the protons into a first flow and hydroxide ions into a second flow, the first flow disposed proximate to a first side of the bipolar membrane composite facing the first flow, the second flow disposed proximate to an opposing second side of the bipolar membrane composite facing the second flow;
   wherein the CEL faces the first flow and the AEL faces the second flow; and
   wherein the first flow includes the acidic flow and the second flow includes the basic flow.

Embodiment 89 is the method of Embodiment 88, wherein:
an anion exchange layer (AEL) including an anion exchange polymer and optionally a AEL reinforcement layer at least partially embedded within the anion exchange polymer;
a cation exchange layer (CEL) including a cation exchange polymer and optionally a CEL reinforcement layer at least partially embedded within the anion exchange polymer; and
wherein at least one of the AEL or CEL has a reinforcement layer having an open structure, defining a plurality of pores having an average pore size of 0.2 μm to 5.0 μm;

Embodiment 90 is the bipolar membrane composite of Embodiment 88 or 89, wherein the additional membrane is a catalyst filled membrane.

Embodiment 91 is the bipolar membrane composite of any one of Embodiments 88 to 90, wherein the additional membrane includes a tight structure defining a plurality of pores having an average pore size of 0.02 μm to 1.0 μm.

Embodiment 92 is the bipolar membrane composite of any one of Embodiments 88 to 91, wherein the additional membrane contains an anion exchange polymer, cation exchange polymer, or ionomer.

Embodiment 93 is a method of creating an acidic flow and a basic flow from a main flow of water, the method including:
applying an electric current to a bipolar membrane composite in an electrochemical apparatus;
wherein the bipolar membrane composite includes:
   a single membrane having a first open structure, an opposing second open structure, and a tight structure between first open structure and the second open structure;
      wherein the open structure defining a plurality of pores having an average pore size of 0.2 μm to 5.0 μm, and the tight structure defining a plurality of pores having an average pore size of 0.2 μm to 1.0 μm;
   an anion exchange polymer at least partially embedded within the first open structure;
   a cation exchange polymer at least partially embedded within the second open structure; and
   a water dissociation catalyst at least partially embedded within the tight structure;
hydrating the bipolar membrane composite with water;
dissociating water at the water dissociation catalyst; and
separating the protons into a first flow and hydroxide ions into a second flow, the first flow disposed proximate to a first side of the bipolar membrane composite facing the first flow, the second flow disposed proximate to an opposing second side of the bipolar membrane composite facing the second flow;
   wherein the first membrane faces the first flow and the second membrane faces the second flow; and
   wherein the first flow includes the acidic flow and the second flow includes the basic flow.

Embodiment 94 is an electrodialysis system, including:
the bipolar membrane composite of any of the preceding Embodiments; a fluid;
a first electrode, the first electrode including an anode; and
a second electrode, the second electrode including a cathode.

Embodiment 95 is the electrodialysis system of Embodiment 94, wherein the fluid is salt water.

Embodiment 96 is the electrodialysis system of Embodiment 94, wherein the fluid is sea water.

Embodiment 97 is the electrodialysis system of Embodiment 94, wherein the fluid includes an electrolyte.

Embodiment 98 is the bipolar membrane composite of any of the preceding Embodiments, wherein the AEL has a thickness of 1-30 μm and the AEL reinforcement layer has a thickness of 1-5 μm.

Embodiment 99 is the bipolar membrane composite of any of the preceding Embodiments, wherein the AEL has a thickness of 1-15 μm and the AEL reinforcement layer has a thickness of 1-3 μm.

Embodiment 100 is the bipolar membrane composite of any of the preceding Embodiments, wherein the AEL reinforcement layer inhibits a counterion flow through the AEL layer.

Embodiment 101 is the bipolar membrane composite of any of the preceding Embodiments, wherein the ratio of AEL layer to AEL reinforcement layer is from 1:1 to 1:20.

Embodiment 102 is the bipolar membrane composite of any of the preceding Embodiments, wherein the AEL reinforcement layer is about 1% to about 60% of the AEL.

Embodiment 103 is the bipolar membrane composite of any of the preceding Embodiments, wherein the CEL has a thickness of 1-60 μm and the CEL reinforcement layer has a thickness of 1-10 μm.

Embodiment 104 is the bipolar membrane composite of any of the preceding Embodiments, wherein the CEL has a thickness of 1-30 μm and the CEL reinforcement layer has a thickness of 1-5 μm.

Embodiment 105 is the bipolar membrane composite of any of the preceding Embodiments, wherein the CEL reinforcement layer inhibits a counterion flow through the CEL layer.

Embodiment 106 is the bipolar membrane composite of any of the preceding Embodiments, wherein the ratio of CEL layer to CEL reinforcement layer is from 1:1 to 1:20.

Embodiment 107 is the bipolar membrane composite of any of the preceding Embodiments, wherein the CEL reinforcement layer is about 1% to about 60% of the CEL.

Embodiment 108 is the bipolar membrane composite of any of the preceding Embodiments, further including a catalyst filled layer.

Embodiment 109 is the bipolar membrane composite of Embodiment 108, wherein the catalyst filled layer includes a reinforcement layer, wherein the reinforcement layer may be intrinsic to the reinforcement layer of the AEL or CEL or an independent reinforcement layer.

Embodiment 110 is the bipolar membrane composite of any of the preceding Embodiments, wherein part of the anion exchange polymer may exceed the volume of the AEL.

Embodiment 111 is the bipolar membrane composite of any of the preceding Embodiments, wherein part of the cation exchange polymer may exceed the volume of the CEL.

Embodiment 112 is a bipolar membrane composite that generates an acidic solution and a basic solution when the membrane composite is exposed to water and an electric current by enabling an oxidation-reduction reaction that dissociates water into a proton component and a hydroxide ion component with each component disposed on opposing sides of the bipolar membrane composite, the bipolar membrane composite including:
an anion exchange layer (AEL) including an anion exchange polymer and optionally an AEL reinforcement layer at least partially embedded within the anion exchange polymer;
a cation exchange layer (CEL) including a cation exchange polymer and optionally a CEL reinforcement layer at least partially embedded within the cation exchange polymer;
wherein at least one of the AEL or CEL has a reinforcement layer having an open structure, defining a plurality of pores having an average pore size of 0.05 μm to 5.0 μm;
a water dissociation catalyst at least partially embedded within at least one of the AEL or CEL such that the water dissociation catalyst is embedded extending from an interface between the AEL and CEL into less than 10% of a thickness of the at least one of the AEL or CEL.

Embodiment 113 is a method of creating an acidic flow and a basic flow from a main flow of water, the method including:
applying an electric current to a bipolar membrane composite in an electrochemical apparatus;
wherein the bipolar membrane composite includes:
an anion exchange layer (AEL) including an anion exchange polymer and optionally a AEL reinforcement layer at least partially embedded within the anion exchange polymer;
a cation exchange layer (CEL) including a cation exchange polymer and optionally a CEL reinforcement layer at least partially embedded within the cation exchange polymer;
wherein at least one of the AEL or CEL has a reinforcement layer having an open structure, defining a plurality of pores having an average pore size of 0.05 μm to 5.0 μm;
a water dissociation catalyst at least partially embedded within at least one of the AEL or CEL such that the water dissociation catalyst is embedded extending from an interface between the AEL and CEL into less than 10% of a thickness of the at least one of the AEL or CEL;
hydrating the bipolar membrane composite with water
dissociating water at the water dissociation catalyst; and
separating the protons into a first flow and hydroxide ions into a second flow, the first flow disposed proximate to a first side of the bipolar membrane composite facing the first flow, the second flow disposed proximate to an opposing second side of the bipolar membrane composite facing the second flow;
wherein the CEL faces the first flow and the AEL faces the second flow;
wherein the first flow includes the acidic flow and the second flow includes the basic flow.

Embodiment 114 is an electrodialysis system, including:
the bipolar membrane composite of Embodiment 112;
a fluid;
a first electrode, the first electrode including an anode; and
a second electrode, the second electrode including a cathode.

Embodiment 115 is the bipolar membrane composite of Embodiment 112, wherein the AEL has a thickness of 1-30 μm and the AEL reinforcement layer has a thickness of 1-5 μm, and wherein the CEL has a thickness of 1-60 μm and the CEL reinforcement layer has a thickness of 1-10 μm.

Embodiment 116 is the bipolar membrane composite of Embodiment 112, wherein the AEL reinforcement layer is about 1 to about 60% of the AEL, or wherein the CEL reinforcement layer is about 1% to about 60% of the CEL.

Embodiment 117 is the bipolar membrane composite of Embodiment 112, further including a catalyst layer, optionally wherein the catalyst layer includes a reinforcement layer, wherein the reinforcement layer may be intrinsic to the reinforcement layer of the AEL or CEL or an independent reinforcement layer.

Embodiment 118 is the bipolar membrane composite of Embodiment 112, wherein part of the anion exchange polymer may exceed the volume of the AEL, or wherein part of the cation exchange polymer may exceed the volume of the CEL.

Embodiment 119 is the bipolar membrane composite of Embodiment 112, wherein the reinforcement layer of the AEL includes pore characteristics configured to enhance transport of hydroxide ions, and wherein the reinforcement layer of the AEL includes a plurality of pores having an average pore size of 0.05 μm to 1.0 μm and a porosity of about 50% to about 90% by volume, or wherein the reinforcement layer of the CEL includes pore characteristics configured to enhance transport of protons, and wherein the reinforcement layer of the CEL includes a plurality of pores having an average pore size of 0.05 μm to 1.0 μm and a porosity of about 50% to about 90% by volume.

Embodiment 120 is the bipolar membrane composite of Embodiment 112, wherein the reinforcement layer of the AEL is configured to balance the mechanical properties of the anion exchange polymer and the reinforcement layer of the CEL is configured to balance the mechanical properties of the cation exchange polymer to reduce interfacial strain, and wherein the interfacial strain of each of the reinforcement layers of the AEL and CEL is independently from about 0.1% to about 5%.

Embodiment 121 is the bipolar membrane composite of Embodiment 120, wherein the balanced mechanical properties include elastic moduli in the x-y direction, and wherein the elastic moduli in the x-y direction of each of the reinforcement layers of the AEL and CEL is independently from about 10 MPA to about 500 MPa.

Embodiment 122 is the bipolar membrane composite of Embodiment 112, wherein the AEL and CEL have balanced hydration levels that provide balanced swelling and prevent dimensional mismatch, and wherein the hydration levels of the AEL and CEL are each independently from about 5% to about 50%.

Embodiment 123 is the bipolar membrane composite of Embodiment 112, wherein the reinforcement layer of the AEL or CEL is positioned to prevent curl of the bipolar membrane composite, and optionally wherein the ratio of the reinforcement layer of the AEL or CEL to the total layer thickness of the AEL or CEL is selected such that the curl is controlled.

Embodiment 124 is the bipolar membrane composite of Embodiment 112, wherein the reinforcement layer of the CEL is positioned relative to the reinforcement layer of the AEL to balance dimensional stability, and optionally wherein the centerlines of both reinforcement layers are aligned within ±1 millimeter across the membrane thickness and the thicknesses of both reinforcement layers differ by no more than 30%.

Embodiment 125 is the bipolar membrane composite of Embodiment 112, wherein a ratio of the anion exchange polymer to the reinforcement layer of the AEL is configured to balance the dimensional stability properties of the CEL, and wherein the AEL reinforcement layer is from about 10% to about 100% of the anion exchange polymer.

Embodiment 126 is the bipolar membrane composite of Embodiment 112, wherein the reinforced catalyst layer includes a microporous structure that provides mechanical support for the water dissociation catalyst.

Embodiment 127 is the bipolar membrane composite of Embodiment 126, wherein the water dissociation catalyst is embedded within a reinforced catalyst layer having a pore size and shape that matches the pore size and shape of the catalyst particles.

Embodiment 128 is the bipolar membrane composite of Embodiment 126, wherein the microporous structure of the reinforced catalyst layer has pore characteristics selected to enhance water transport to the water dissociation catalyst, and wherein the pore characteristics include an average pore size from about 0.05 μm to about 1.0 μm and a porosity from about 50% to about 90% by volume.

Embodiment 129 is the bipolar membrane composite of Embodiment 112, wherein both the reinforcement layer of the AEL and the reinforcement layer of the CEL are positioned to control swelling behavior and dimensional stability.

Embodiment 130 is the bipolar membrane composite of Embodiment 129, wherein the total swelling of the bipolar membrane composite upon hydration is about 10% to about 45%, wherein the total swelling refers to the volumetric increase of the bipolar membrane composite upon hydration.

Embodiment 131 is the bipolar membrane composite of Embodiment 112, wherein the anion exchange polymer and cation exchange polymers include chemical backbones that are substantially similar to each other.

Embodiment 132 is a method of generating water and energy from an acidic flow and a basic flow, the method comprising:
applying an electric current to a bipolar membrane composite in an electrochemical apparatus;
wherein the bipolar membrane composite includes:
   an anion exchange layer (AEL) comprising an anion exchange polymer and optionally an AEL reinforcement layer at least partially embedded within the anion exchange polymer;
   a cation exchange layer (CEL) comprising a cation exchange polymer and optionally a CEL reinforcement layer at least partially embedded within the cation exchange polymer;
      wherein at least one of the AEL or CEL has a reinforcement layer having an open structure, defining a plurality of pores having an average pore size of 0.05 μm to 5.0 μm;
      a catalyst at least partially embedded within at least one of the AEL or CEL such that the catalyst is embedded extending from an interface between the AEL and CEL into less than 10% of a thickness of the at least one of the AEL or CEL;
contacting the bipolar membrane composite with an acidic flow on a first side and a basic flow on an opposing second side;
transporting protons from the acidic flow through the CEL toward the interface and transporting hydroxide ions from the basic flow through the AEL toward the interface;
combining the protons and hydroxide ions at the catalyst to form water;
wherein the CEL faces the acidic flow and the AEL faces the basic flow.

The foregoing Examples are just that and should not be read to limit or otherwise narrow the scope of any of the inventive embodiments otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1A is an illustration showing a bipolar membrane composite including a first membrane including a tight structure—open structure configuration, and a second membrane including an open structure—tight structure configuration;

FIG. 1B is an illustration showing a bipolar membrane composite including a first membrane including an open structure—tight structure configuration, and a second membrane including a tight structure—open structure configuration;

FIG. 1C is an illustration showing a bipolar membrane composite including an open structure—tight structure configuration, an additional membrane, and a second membrane including a tight structure—open structure configuration;

FIG. 1D is an illustration showing a bipolar membrane composite including a first membrane including an open structure, an additional membrane including a tight structure, and a second membrane including an open structure;

FIG. 1E is an illustration showing a bipolar membrane composite including a first membrane including a tight structure—open structure configuration, an additional membrane, and a second membrane including an open structure—tight structure configuration;

FIG. 1F is an illustration showing a bipolar membrane composite including a first membrane including an open structure and a tight structure, and a second membrane including an open structure;

FIG. 1G is an illustration showing a bipolar membrane composite including a first membrane including an open structure, an additional membrane, and a second membrane including an open structure;

FIG. 1H is an illustration showing a bipolar membrane composite including a first membrane including an open structure, and a second membrane including an open structure;

FIG. 1I is an illustration showing a bipolar membrane composite including a single membrane including a first open structure; a tight structure; and a second open structure;

FIG. 1J is an illustration showing a bipolar membrane composite including a first membrane including an open structure and a tight structure, a second membrane including an open structure, and an additional membrane;

FIG. 1K is an illustration showing a bipolar membrane including a first membrane with an open structure, a second membrane with a tight structure, and an additional membrane;

FIG. 1L is an illustration showing a bipolar membrane composite including a first membrane including an open structure and a tight structure, a second membrane including a tight structure, and an additional membrane;

FIG. 1M is an illustration showing a bipolar membrane composite including a first membrane including a buttercoat—tight structure—open structure configuration, and a second membrane including an open structure—tight structure—buttercoat configuration;

FIG. 1N is an illustration showing a bipolar membrane composite including a first membrane including a buttercoat-open structure-tight structure configuration, and a second membrane including a tight structure—open structure—buttercoat configuration;

FIG. 1O is an illustration showing a bipolar membrane composite including a first membrane including a buttercoat—open structure—tight structure configuration, an additional membrane, and a second membrane including a tight structure—open structure—buttercoat configuration;

FIG. 1P is an illustration showing a bipolar membrane composite including a first membrane including a buttercoat—open structure configuration, an additional membrane including a tight structure configuration, and a second membrane including an open structure—buttercoat configuration;

FIG. 1Q is an illustration showing a bipolar membrane composite including a first membrane including a buttercoat—tight structure—open structure configuration, an additional membrane, and a second membrane including an open structure—tight structure—buttercoat configuration;

FIG. 1R is an illustration showing a bipolar membrane composite including a first membrane including a buttercoat, an open structure and a tight structure, and a second membrane including an open structure and a buttercoat;

FIG. 1S is an illustration showing a bipolar membrane composite including a first membrane including a buttercoat, an open structure, an additional membrane, and a second membrane including an open structure and a buttercoat;

FIG. 1T is an illustration showing a bipolar membrane composite including a first membrane including a buttercoat and an open structure, and a second membrane including an open structure and a buttercoat;

FIG. 1U is an illustration showing a bipolar membrane composite including a single membrane including a buttercoat, a first open structure; a tight structure; a second open structure, and a buttercoat;

FIG. 1V is an illustration showing a bipolar membrane composite including a first membrane including a buttercoat, an open structure, and a tight structure, a second membrane including an open structure and a buttercoat, and an additional membrane;

FIG. 1W is an illustration showing a bipolar membrane composite including a first membrane including a buttercoat and an open structure, a second membrane including a tight structure and a buttercoat, and an additional membrane;

FIG. 1X is an illustration showing a bipolar membrane composite including a first membrane including a buttercoat, an open structure, and a tight structure, a second membrane including a tight structure and a buttercoat, and an additional membrane;

FIG. 2A is an illustration showing a bipolar membrane composite including a first membrane including a tight structure—open structure—buttercoat configuration, and a second membrane including a buttercoat—open structure—tight structure configuration;

FIG. 2B is an illustration showing a bipolar membrane composite including a first membrane with an open structure—tight structure—buttercoat configuration, and a second membrane including a buttercoat—tight structure—open structure configuration;

FIG. 2C is an illustration showing a bipolar membrane composite including a first membrane including an open structure—tight structure—buttercoat configuration, an additional membrane, and a second membrane including a buttercoat—tight structure—open structure configuration;

FIG. 2D is an illustration showing a bipolar membrane composite including a first membrane including a tight structure—open structure—buttercoat configuration, an additional membrane, and a second membrane including a buttercoat—open structure—tight structure configuration;

FIG. 2E is an illustration showing a bipolar membrane composite including a first membrane including an open structure, a tight structure, and a buttercoat, and a second membrane including a buttercoat and an open structure;

FIG. 2F is an illustration showing a bipolar membrane composite including a first membrane including an open structure and a buttercoat, an additional membrane, and a second membrane including a buttercoat and an open structure;

FIG. 2G is an illustration showing a bipolar membrane composite including a first membrane including an open structure and a buttercoat, and a second membrane including a buttercoat and an open structure;

FIG. 2H is an illustration showing a bipolar membrane composite including a first membrane including an open structure, a tight structure, and a buttercoat, a second membrane including a buttercoat and an open structure, and an additional membrane;

FIG. 2I is an illustration showing a bipolar membrane composite including a first membrane including an open structure and a buttercoat, a second membrane including a buttercoat and a tight structure, and an additional membrane;

FIG. 2J is an illustration showing a bipolar membrane composite including a first membrane including an open structure, a tight structure, and a buttercoat, a second membrane including a buttercoat and a tight structure, and an additional membrane;

FIG. 2K is an illustration showing a bipolar membrane composite including a first membrane including a buttercoat—tight structure—open structure—buttercoat configuration, and a second membrane including a buttercoat—open structure—tight structure—buttercoat configuration;

FIG. 2L is an illustration showing a bipolar membrane composite including a first membrane with a buttercoat—open structure—tight structure—buttercoat configuration, and a second membrane including a buttercoat—tight structure—open structure—buttercoat configuration;

FIG. 2M is an illustration showing a bipolar membrane composite including a first membrane including a buttercoat—open structure—tight structure—buttercoat configuration, an additional membrane, and a second membrane including a buttercoat—tight structure—open structure—buttercoat configuration;

FIG. 2N is an illustration showing a bipolar membrane composite including a first membrane including a buttercoat—tight structure—open structure—buttercoat configuration, an additional membrane, and a second membrane including a buttercoat—open structure—tight structure—buttercoat configuration;

FIG. 2O is an illustration showing a bipolar membrane composite including a first membrane including a buttercoat, an open structure, a tight structure, and a buttercoat, and a second membrane including a buttercoat, an open structure, and a buttercoat;

FIG. 2P is an illustration showing a bipolar membrane composite including a first membrane including a buttercoat, an open structure, and a buttercoat, an additional membrane, and a second membrane including a buttercoat, an open structure, and a buttercoat;

FIG. 2Q is an illustration showing a bipolar membrane composite including a first membrane including a buttercoat, an open structure, and a buttercoat, and a second membrane including a buttercoat, an open structure, and a buttercoat;

FIG. 2R is an illustration showing a bipolar membrane composite including a first membrane including a buttercoat, an open structure, a tight structure, and a buttercoat, and a second membrane including a buttercoat, an open structure, and a buttercoat, and an additional membrane;

FIG. 2S is an illustration showing a bipolar membrane composite including a first membrane including a buttercoat, an open structure, and a buttercoat, a second membrane including a buttercoat, a tight structure, and a buttercoat, and an additional membrane;

FIG. 2T is an illustration showing a bipolar membrane composite including a first membrane including a buttercoat, an open structure, a tight structure, and a buttercoat, a second membrane including a buttercoat, a tight structure, and a buttercoat, and an additional membrane;

FIG. 3 is a scanning electron microscope (SEM) image of a membrane including an open structure and a tight structure;

FIG. 4A is a scanning electron microscope (SEM) image of an open structure of a membrane;

FIG. 4B is a scanning electron microscope (SEM) image of a tight structure of a membrane;

FIG. 4C is a scanning electron microscope (SEM) image of a cross-section of an open structure with a gradient of pore sizes/tight structure of a membrane;

FIG. 4D is plot of an exemplary pore size distribution of an open structure and a tight structure of a membrane;

FIG. 5 is a scanning electron microscope (SEM) image of cross-section of a multilayer membrane like the one illustrated in FIG. 11;

FIG. 6A is a scanning electron microscope (SEM) image of cross-section of a multilayer membrane like the one illustrated in FIG. 2Q; and

FIG. 6B is a scanning electron microscope (SEM) image of a cross-section of the multilayer membrane of FIG. 6A, where the image specifically shows the catalyst layer at the interface of the AEL and the CEL.

Corresponding reference characters indicate corresponding parts throughout the several views. The exemplifications set out herein illustrate the disclosure, and such exemplifications are not to be construed as limiting the scope of the disclosure in any manner.

### DETAILED DESCRIPTION

For the purposes of promoting an understanding of the principles of the present disclosure, reference is now made to the embodiments illustrated in the drawings, which are described below. The exemplary embodiments disclosed herein are not intended to be exhaustive or to limit the disclosure to the precise form disclosed in the following detailed description. Rather, these exemplary embodiments were chosen and described so that others skilled in the art may utilize their teachings.

Persons skilled in the art will readily appreciate that various embodiments of the present disclosure can be realized by any number of methods and apparatus configured to perform the intended functions. It should also be noted that the accompanying drawing figures referred to herein are not necessarily drawn to scale but may be exaggerated to illustrate various embodiments of the present disclosure, and in that regard, the drawing figures should not be construed as limiting.

### I. Definitions and Terminology

This disclosure is not mean to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

As used herein, the terms “ionomer” and “ion exchange material” refer to a cation exchange material or an anion exchange material. Ion exchange material may be perfluorinated or hydrocarbon-based. Suitable ion exchange materials include, for example, perfluorosulfonic acid polymers, perfluorocarboxylic acid polymers, perfluorophosphonic acid polymers, styrenic ion exchange polymers, fluorostyrenic ion exchange polymers, polyarylether ketone ion exchange polymers, polysulfone ion exchange polymers, bis(fluoroalkylsulfonyl)imides, (fluoroalkylsulfonyl)(fluorosulfonyl)imides, polyvinyl alcohol, polyethylene oxides, divinyl benzene, metal salts with or without a polymer, and mixtures thereof. As used herein, ion exchange material may be partly or fully embedded within a microporous polymer structure. For example, the ion exchange material may exceed the volume of the anion exchange reinforcement membrane or layer and/or cation exchange reinforcement membrane or layer.

As used herein, the term “partially embedded” may refer to a composition that is embedded into a porous structure such that at least 1% of the pores of the structure are rendered occlusive. The term “fully embedded” may refer to a composition that is embedded into a porous structure such that 100%, or nearly 100%, of the pores of the structure are rendered occlusive.

As used herein, the term “microporous polymer structure” refers to a polymeric matrix that may support the ion exchange material, catalyst, or other embedded composition, adding structural integrity and durability to the resulting composite membrane. In some exemplary embodiments, the microporous polymer structure includes expanded polytetrafluoroethylene (ePTFE) having a node and fibril structure. In other exemplary embodiments, the microporous polymer structure includes track etched polycarbonate membranes having smooth flat surfaces, high apparent density, and well defined pore sizes. In other exemplary embodiments, the microporous polymer structure may include non-woven or woven polyetheretherketone (PEEK).

As used herein, an interior volume of a microporous polymer structure is referred to as occlusive or “substantially occlusive” when said interior volume has structures that are characterized by low volume of voids, less than 10% by volume, and being highly impermeable to gases, Gurley numbers larger than 10000 s. Conversely, interior volume of microporous polymer structure is referred to as “non-occluded” when said interior volume has structures that is characterized by large volume of voids, more than 10% by volume, and being permeable to gases, Gurley numbers less than 10000s.

The microporous polymer structure may be partially, substantially or completely rendered occlusive by embedded ion exchange material, catalyst materials, inert materials, or combinations thereof.

As used herein, the term “adjacent” is intended to mean two neighboring elements, such as a microporous polymer structure, porous membrane layers, layer of ion exchange material or layer of catalyst material, which do not have an element of the same type(s) between them, for instance when viewed along an axis perpendicular to the planes of the layers. Thus, a pair of adjacent microporous polymer material layers are two neighboring layers of microporous polymer material which do not have an intervening layer of microporous polymer material between them. However, such adjacent elements of the same type may be separated by one or more elements of a different type. For instance, a pair of adjacent microporous polymer material layers may be separated by one or more layers of ion exchange material, catalyst material, inert materials, and/or one or more porous layers.

As used herein, the “equivalent weight” of an ion exchange material or ionomer refers to the weight of polymer (in molecular mass) in the ion exchange material or ionomer per number of active ion exchange sites. Thus, a lower equivalent weight indicates a greater proportion of active ion exchange sites. The equivalent weight (EW) of the ion exchange material or ionomer refers to the EW if that ion exchange material or ionomer were in its ion exchange material form at 0% RH (relative humidity) with negligible impurities.

As used herein, the term “ion exchange capacity” refers to the inverse of equivalent weight (1/EW). Thus, a higher ion exchange capacity (IEC) indicates a greater proportion of active ion exchange sites.

As used herein, the “equivalent volume” of an ion exchange material or ionomer refers to the volume of the ion exchange material or ionomer per number of active ion exchange sites. Thus, a lower equivalent volume indicates a greater proportion of active ion exchange sites. The equivalent volume (EV) of the ion exchange material or ionomer refers to the EV if that ionomer were pure and in its ion exchange material form at 0% RH, with negligible impurities.

As used herein, the term “surface” is intended to mean the viewable surface or portion of the material that interacts with the exterior environment. The surface may be the portion of the material, such as a membrane, that engages adjoining structures or substances. Thus, the surface of a material may be functionally relevant to the environment or adjoining structures/substances. Further, the surface of a material may be a thin layer of the material defining an exterior of the material. The surface of a material has a specific depth from the exterior surface by, for example, 2%, 5%, 8%, 10%, 15%, etc. of the total thickness of the material, such as a first or second membrane of the bipolar membrane composite.

As used herein, the term “first membrane” when referring to a membrane of the bipolar membrane composite may refer to either (i) an anion exchange layer (AEL) reinforcement membrane, wherein a first ion exchange material is at least partially embedded within the AEL reinforcement membrane or (ii) an anion exchange layer (AEL) including an anion exchange polymer and optionally an AEL reinforcement layer at least partially embedded within the anion exchange polymer.

As used herein, the term “second membrane” when referring to a membrane of the bipolar membrane composite may refer to either (i) cation exchange layer (CEL) reinforcement membrane, wherein a second ion exchange material is at least partially embedded within the CEL reinforcement membrane or (ii) a cation exchange layer (CEL) including a cation exchange polymer and optionally a CEL reinforcement layer at least partially embedded within the cation exchange polymer.

As used herein, the term “buttercoat” when referring to the embodiments wherein part of the first and/or second ion exchange material exceeds the volume of the first membrane and/or the second membrane may refer to an extended, uniform, and continuous layer of ion exchange material that protrudes beyond the volume of the first and/or second membranes. This excess material forms a seamless coating and/or layer that remains structurally integrated with the first and/or second membrane.

As used herein, the terms “tight structure” and “tight” can be used interchangeably when referring to the first membrane and/or second membrane. Moreover, the terms “tight structure” and “tight” refer to a first membrane and/or second membrane including a plurality of pores having an average pore size of 0.2 μm to 5.0 μm.

As used herein, the terms “open structure” and “open” can be used interchangeably when referring to the first membrane and/or second membrane.

Moreover, the terms “open structure” and “open” refer to a first membrane and/or second membrane including a plurality of pores having an average pore size of 0.02 μm to 1.0 μm.

### II. Bipolar Membrane Composite

The present disclosure provides a bipolar membrane composite that causes a water dissociation reaction in the presence of water, an electrolyte, and an applied voltage and causes an ion exchange across the bipolar membrane composite to separate the resulting protons and hydroxide ions. The protons create an acidic solution on a first side of the membrane and the hydroxide ions create a basic solution on a second side of the membrane. The bipolar membrane composite may be used in a variety of applications, such as, carbon dioxide removal, carbon capture, carbon dioxide reduction, sodium sulfate remediation, metal recovery, and reduction of N₂ to ammonia.

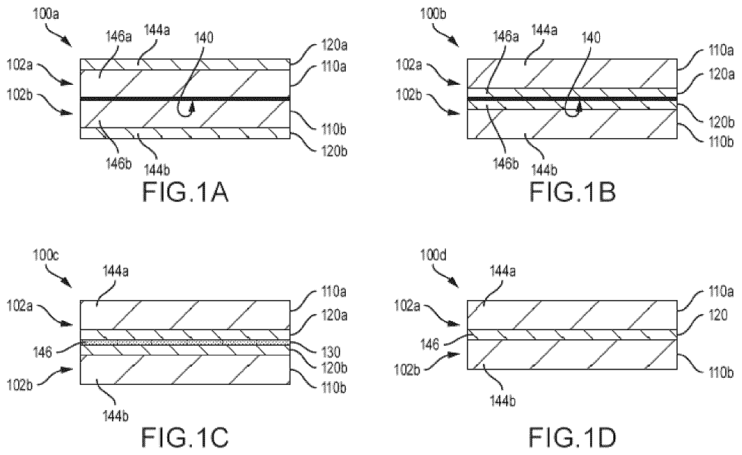

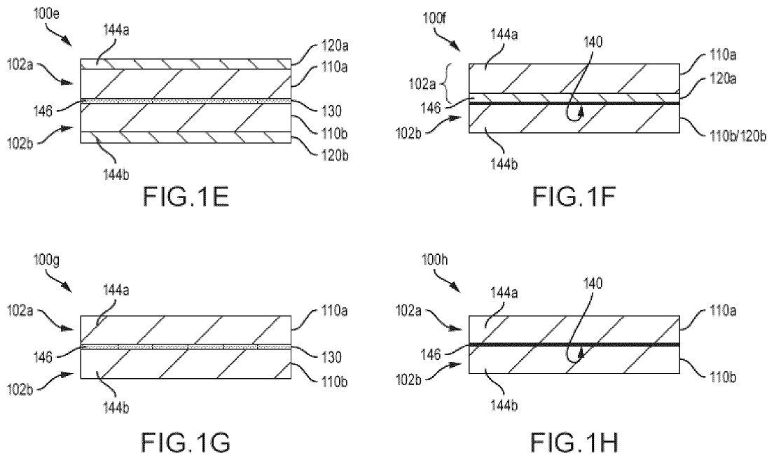

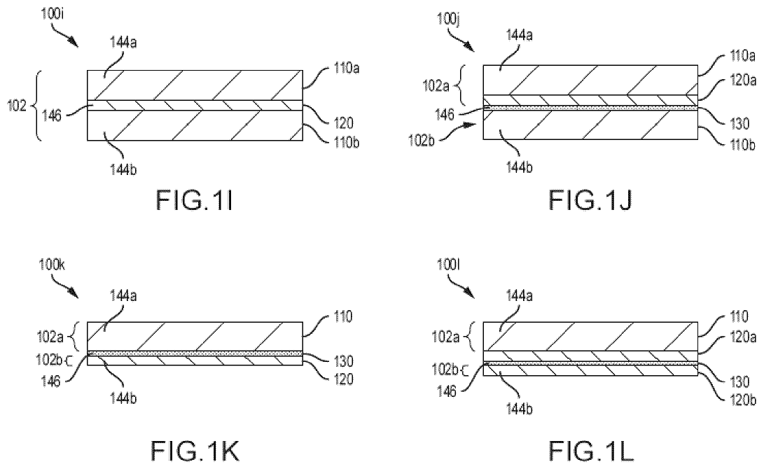

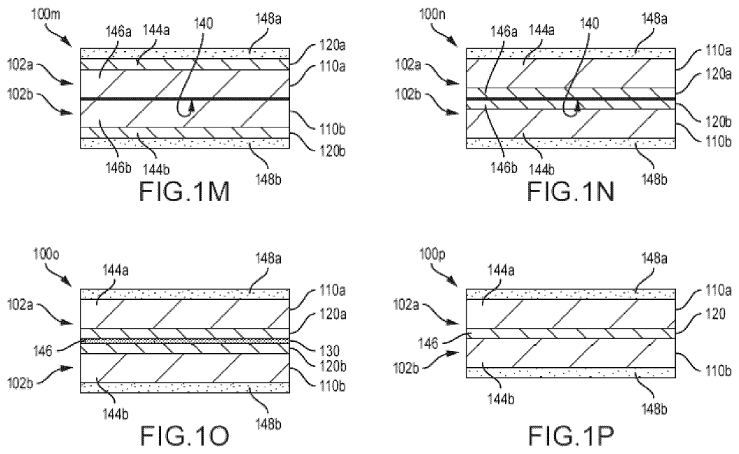

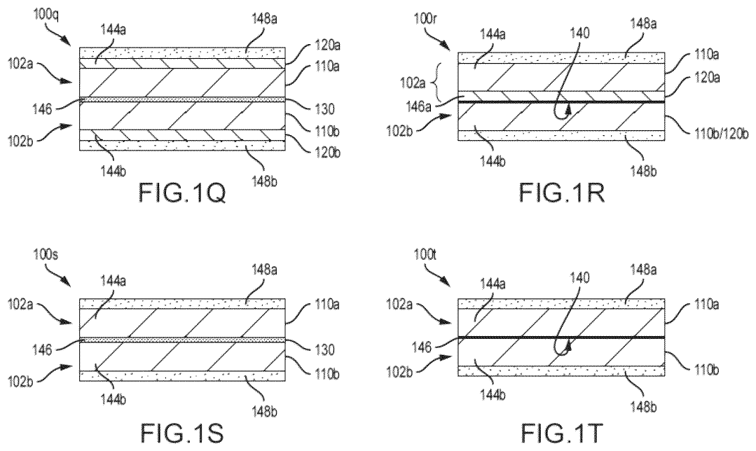

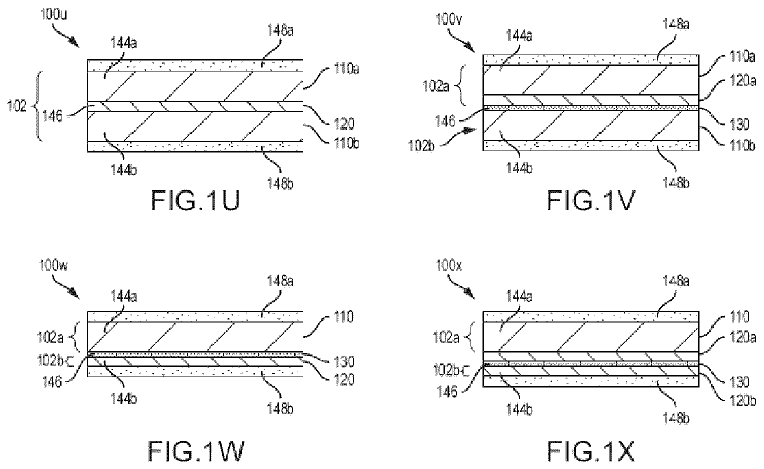

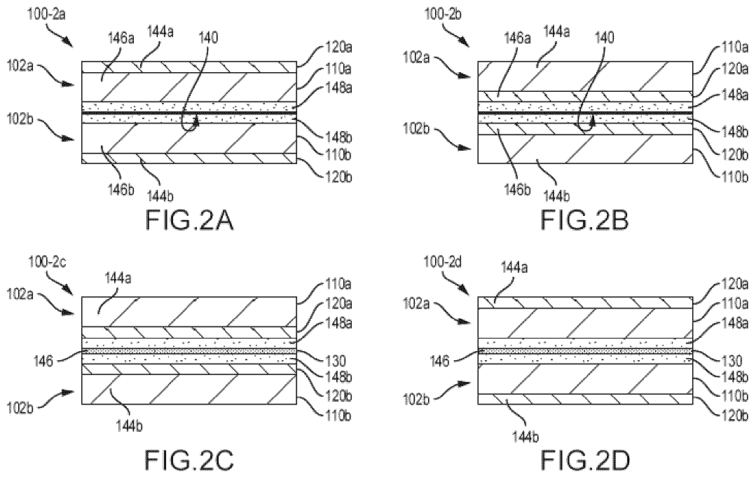

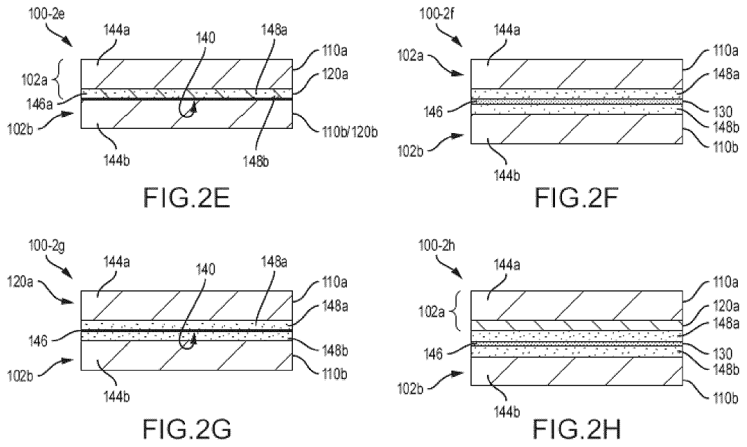

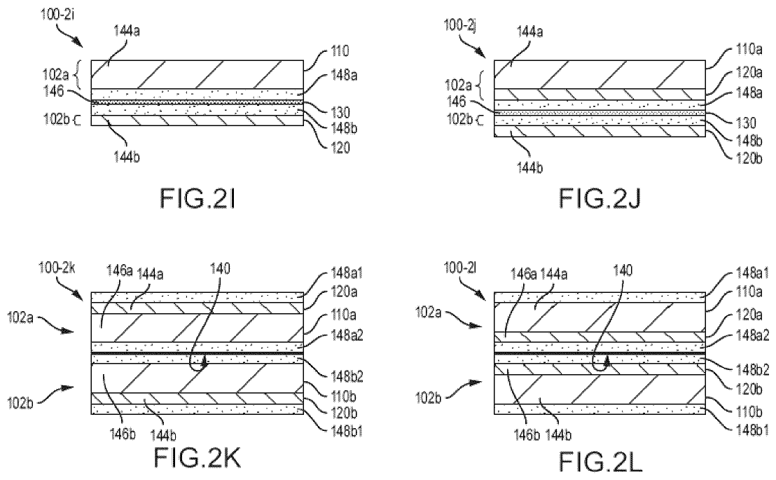

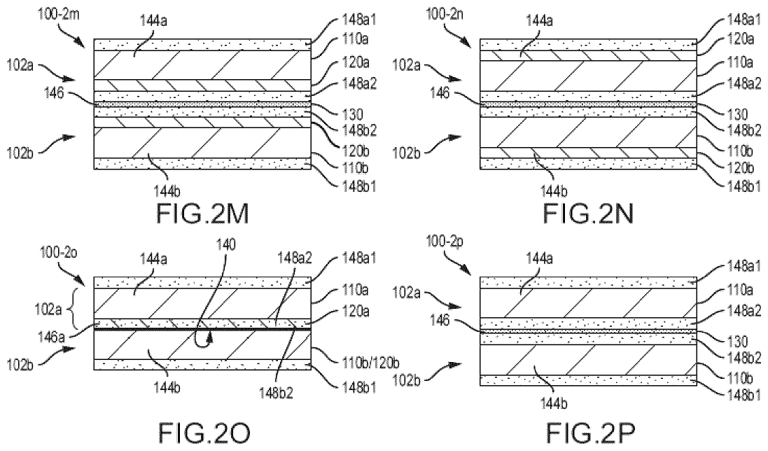

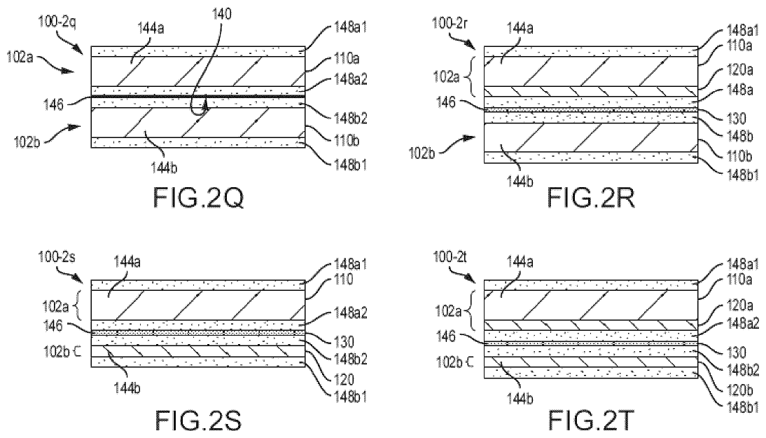

As seen in FIGS. 1A-2T, a bipolar membrane composite 100a, 100b, 100c, 100d, 100e, 100f, 100g, 100h, 100i, 100j, 100k, 1001, 100m, 100n, 1000, 100p, 100q, 100r, 100s, 100t, 100u, 100v, 100w, 100x, 100-2a, 100-2b, 100-2c, 100-2d, 100-2e, 100-2f, 100-2g, 100-2h, 100-2i, 100-2j, 100-2k, 100-2l, 100-2m, 100-2n, 100-2o, 100-2p, 100-2q, 100-2r, 100-2s, and 100-2t may include at least one of a single membrane 102, a first membrane 102a, a second membrane 102b, a first ion exchange material 144a, a second ion exchange material 144b, a catalyst 146, and an additional membrane 130. Like numerals refer to the same features of the membrane across the various figures. In some embodiments, the first membrane may be an anion exchange layer including an anion exchange layer (AEL) reinforcement membrane, wherein a first ion exchange material is at least partially embedded within the AEL reinforcement membrane. In some embodiments, the second membrane may be a cation exchange layer including a cation exchange layer (CEL) reinforcement membrane, wherein a second ion exchange material is at least partially embedded within the CEL reinforcement membrane. In other embodiments, the first membrane may be an anion exchange layer (AEL) including an anion exchange polymer and optionally an AEL reinforcement layer at least partially embedded within the anion exchange polymer. In other embodiments, the second membrane may be cation exchange layer (CEL) including a cation exchange polymer and optionally a CEL reinforcement layer at least partially embedded within the cation exchange polymer. The AEL or CEL reinforcement layer inhibits a counterion flow through the AEL or CEL, respectively.

### A. Membranes

The bipolar membrane composite of the present disclosure may include at least one of a single membrane 102, a first membrane 102a, a second membrane 102b, and optionally, an additional membrane 130. Each membrane may include a microporous polymer structure.

In some embodiments, the first membrane may be an anion exchange layer (AEL) including an anion exchange polymer and optionally an AEL reinforcement layer at least partially embedded within the anion exchange polymer. In some embodiments, the ratio of AEL to AEL reinforcement layer is from about 1:1 to about 1:20, e.g., 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, or 1:20. In some embodiments, the AEL reinforcement layer is about 1% to about 60% of the AEL, e.g., about 1%, about 5%, about 10%, about 15%, about 20%, about 25%, about 30%, about 35%, about 40%, about 45%, about 50%, about 55%, or about 60%. In some embodiments, the AEL has a thickness of about 1 to about 30 μm, e.g., about 1 μm, about 5 μm, about 10 μm, about 15 μm, about 20 μm, about 25 μm, or about 30 μm. In some embodiments, the AEL reinforcement layer has a thickness of about 1 to about 5 μm, e.g., about 1 μm, about 1.5 μm, about 2 μm, about 2.5 μm, about 3 μm, about 3.5 μm, about 4 μm, about 4.5 μm, or about 5 μm.

In some embodiments, the second membrane may be a cation exchange layer (CEL) including a cation exchange polymer and optionally a CEL reinforcement layer at least partially embedded within the anion exchange polymer. In some embodiments, the ratio of CEL to CEL reinforcement layer is from about 1:1 to about 1:20, e.g., 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, or 1:20. In some embodiments, the CEL reinforcement layer is about 1% to about 60% of the CEL, e.g., about 1%, about 5%, about 10%, about 15%, about 20%, about 25%, about 30%, about 35%, about 40%, about 45%, about 50%, about 55%, or about 60%. In some embodiments, the CEL has a thickness of about 1 to about 60 μm, e.g., about 1 μm, about 5 μm, about 10 μm, about 15 μm, about 20 μm, about 25 μm, about 30 μm, about 35 μm, about 40 μm, about 45 μm, about 50 μm, about 55 μm, or about 60 μm. In some embodiments, the CEL reinforcement layer has a thickness of about 1 to about 10 μm, e.g., about 1 μm, about 1.5 μm, about 2 μm, about 2.5 μm, about 3 μm, about 3.5 μm, about 4 μm, about 4.5 μm, about 5 μm, about 5.5 μm, about 6 μm, about 6.5 um, about 7 μm, about 7.5 μm, about 8 μm, about 8.5, about 9 μm, about 9.5 μm, or about 10 μm.

Each of the membranes may include at least one microporous polymer structure of woven material, non-woven material, or a combination thereof. Alternatively, at least one porous structure of the membrane may be a non-woven material such as a mesh, a knitted material, paper, felt, mat or cloth. Combinations of a woven material and a non-woven material are also within the scope of this disclosure.

In some embodiments, the at least one microporous polymer structure may include at least one fluorinated polymer, a non-fluorinated polymer, polyethylene (PE), polystyrene (PS), cyclic olefin copolymer (COC), fluorinated ethylene propylene (FEP), perfluoroalkoxy alkanes (PFAs), polyetherimide (PEI), polysulfone (PSU), polyethersulfone (PES), polyphenylene oxide (PPO), polyphenyl ether (PPE) polymethylpentene (PMP), polyethyleneterephthalate (PET), polycarbonate (PC), expanded polyethylene (ePE), polytetrafluoroethylene (PTFE), poly(ethylene-co-tetrafluoroethylene) (ETFE), expanded polytetrafluoroethylene (ePTFE), polyvinylidene fluoride (PVDF), expanded polyvinylidene fluoride (ePVDF), expanded poly(ethylene-co-tetrafluoroethylene) (eETFE), polyetheretherketone (PEEK), and mixtures thereof.

Microporous polymers for the plurality of porous structures may be fabricated by processes known in the art, such as paste processing, extrusion, and the like.

In other embodiments, the fiber or fibrous material forming the woven material or non-woven material of the plurality of porous structures may be a thermoplastic polymer. Such fiber or fibrous material may include epoxy resin, phenolic resin polyurethanes urea-formaldehyde resin, melamine resin polyesters, e.g. polyethylene terephthalate, polyamides, polyethers, polycarbonates, polyimides, polysulphones, polyphenylene oxides, polyacrylates, polymethacrylates, polyolefin, e.g., polyethylene and polypropylene, styrene and styrene based random and block copolymers, e g., styrene-butadiene-styrene, polyvinyl chloride, or fluorinated polymers, e.g., polyvinylidene fluoride and polytetrafluoroethylene. Non-woven materials for the plurality of porous structures may be fabricated by processes known in the art, such as melt blown fibers, spunbonding, carding and the like.

In one embodiment, the fiber or fibrous material includes at least one of polyurethanes, polyesters, polyamides. polyethers, polycarbonates, polyimides, polysulphones, polyphenylene oxides polyacrylates polymethacrylates, polyolefin, styrene and styrene based random and block copolymers, polyvinyl chloride and fluorinated polymers.

In an alternative embodiment, at least one porous structure includes a hydrocarbon polymer, such as a hydrocarbon polymer fiber or hydrocarbon polymer fibrous material. The hydrocarbon polymer may be selected from the group including polyethylene, polypropylene, polycarbonate, polystyrene, and mixtures thereof.

In some embodiments, the fibers may have aspect ratios of the length to width and length to thickness both of which are greater than about 10 and a width to thickness aspect ratio of less than about 5. Both the length to thickness and length to width aspect ratios of the fiber may be between about 10 and about 1000000, between 10 and about 100000, between 10 and about 1000, between 10 and about 500, between 10 and about 250, between 10 and about 100, between about 10 and about 50, between about 20 and about 1000000, between 20 and about 100000, between 20 and about 1000, between 20 and about 500, between 20 and about 250. between 20 and about 100 or even between about 20 and about 50, or within any range encompassed by the foregoing.

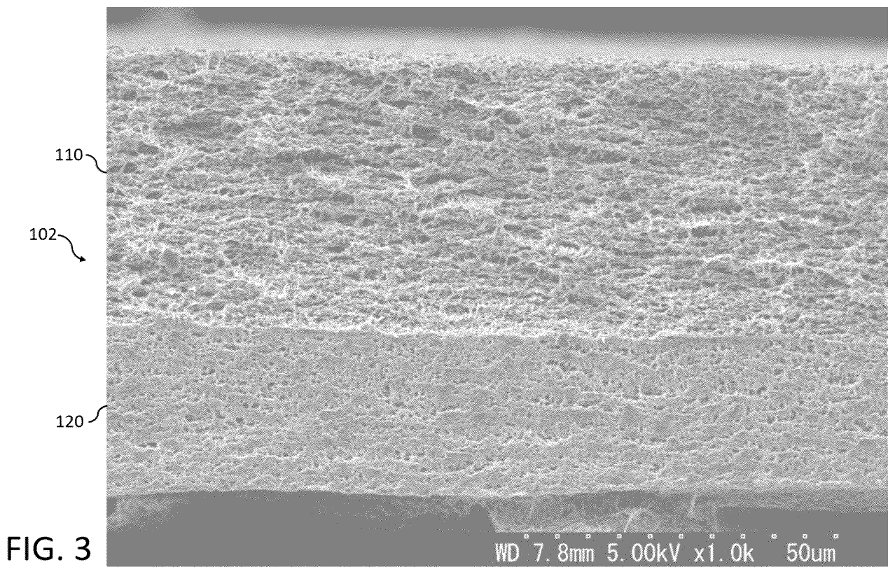

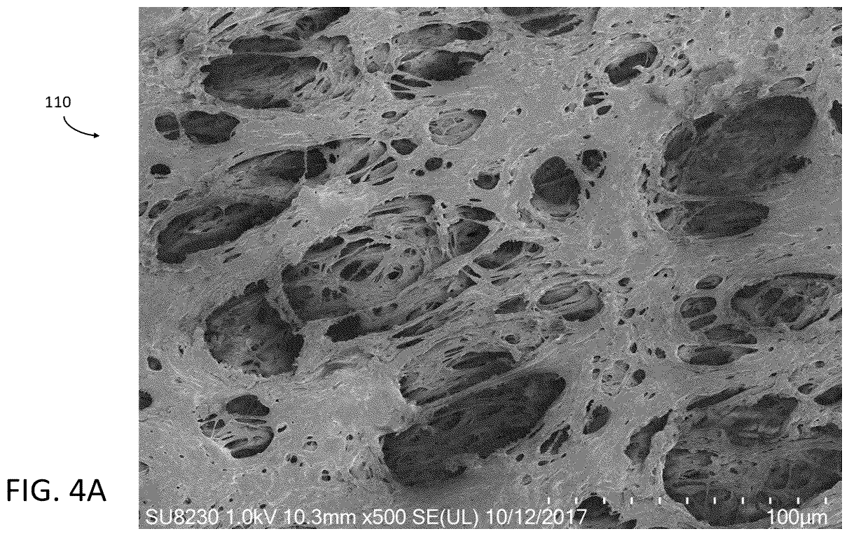

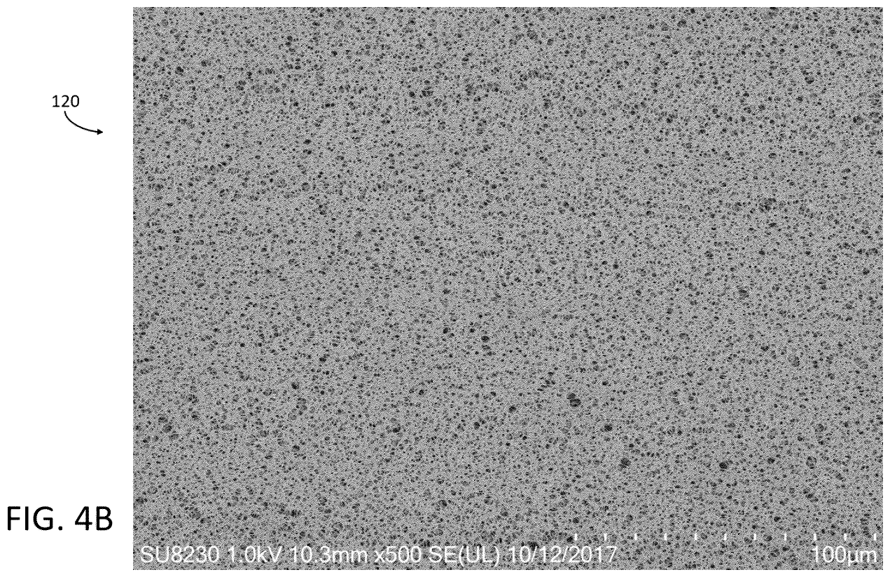

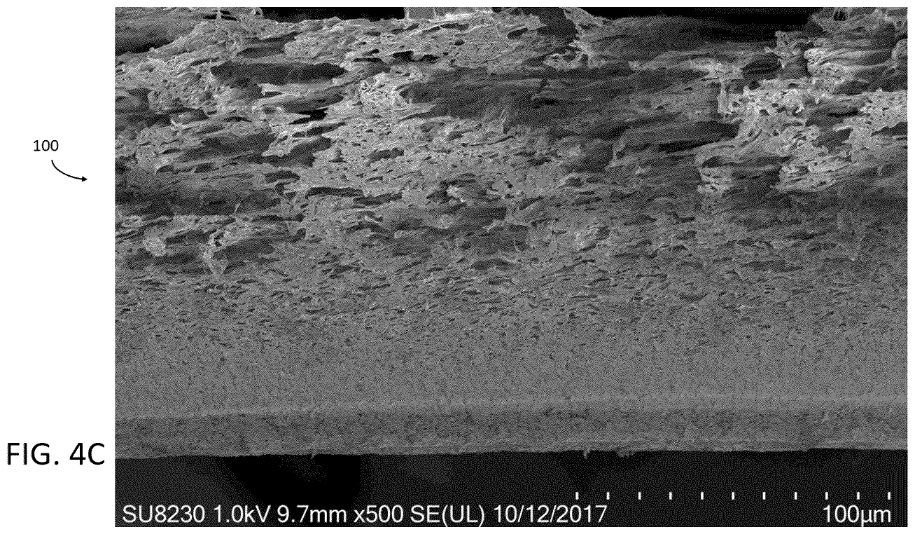

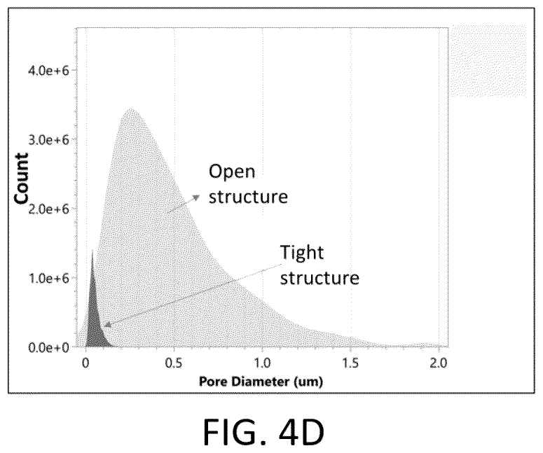

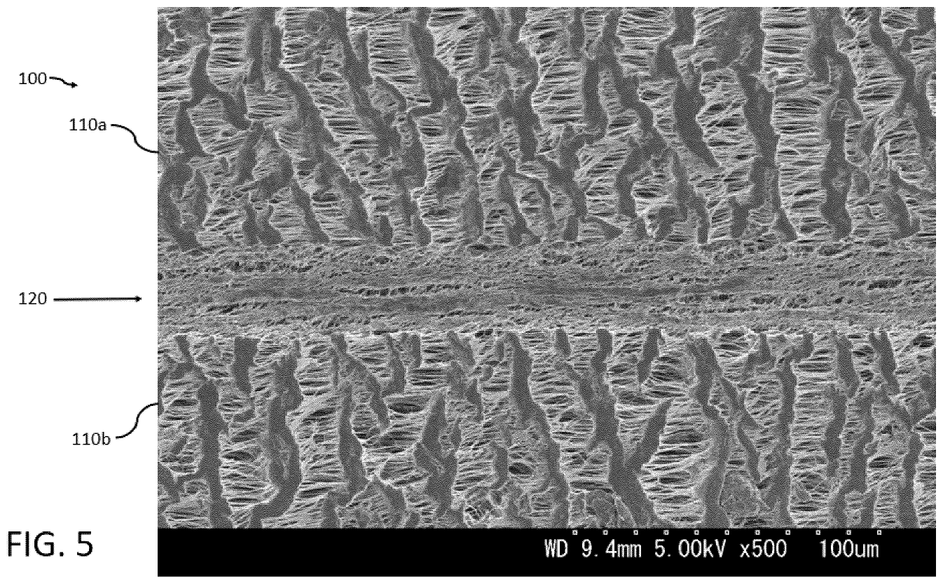

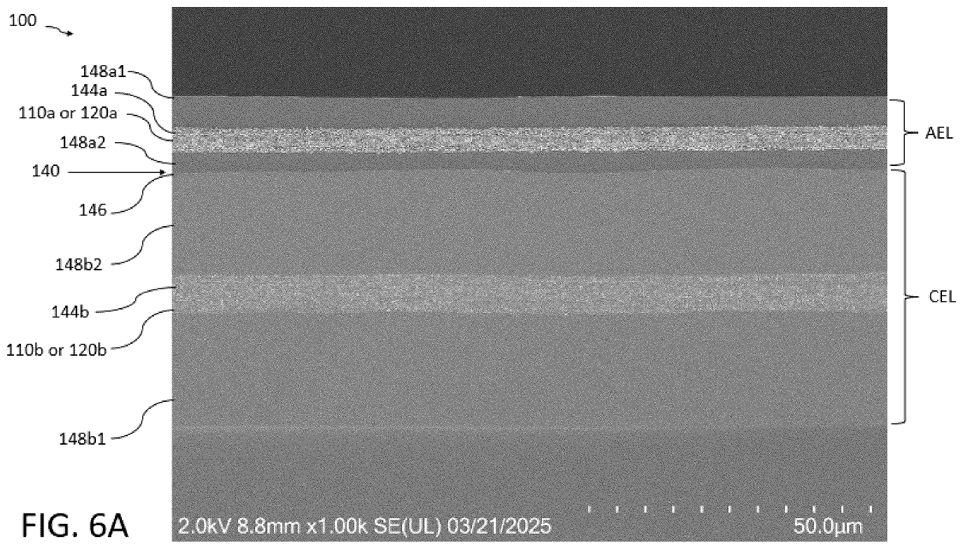

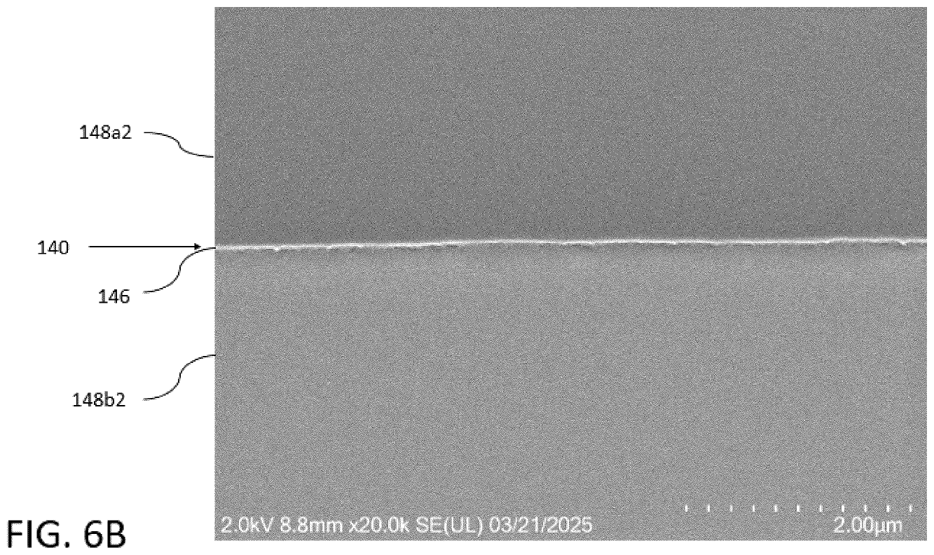

Referring to FIGS. 1A-2T, each of the single membrane 102, first membranes 102a, and second membranes 102b may include at least one porous structure. The single membrane 102, first membranes 102a, and second membranes 102b may each include an open structure 110 and a tight structure 120, as shown in FIGS. 3 and 5. The scanning electron microscopy (SEM) image of the membrane shown in FIG. 5 is to scale according to the scale at the bottom of the image. The open 110 and tight 120 structures of the microporous polymer structure of each membrane of the bipolar membrane composite are shown in detail in FIGS. 4A and 4B. The scanning electron microscopy (SEM) image of the membrane shown in FIG. 6A is to scale according to the scale at the bottom of the image. The interface 140 and catalyst layer 146 of the microporous polymer structure of each membrane having buttercoats on either side of the interface 140 is shown in detail in FIG. 6B, which is to scale according to the scale at the bottom of the image

Each structure may include a plurality of pore sizes. The plurality of pores may provide one or more passages extending between a first surface, such as a first external surface and an opposing second surface, such as a second external surface opposite to that of the first surface, of a membrane. The pores represent continuous channels which extend between the external surfaces of the porous structure such that ions may be conducted from one surface of the membrane, along the pores, to another surface of the membrane, thereby providing an ionic conduction path from an exterior surface of the first porous structure, through the first porous structure, and the second porous structure, to an exterior surface of the second porous structure or vice versa.

The smaller pore size/denser portion is referred to herein as the “tight structure” with the large pore size/less dense structure referred to herein as the “open structure.”

The porosity of a membrane, such as the first, second or additional membrane, may gradually change from an open structure pore size to a tight structure pore size. Such gradual change in porosity may create a gradient of pore sizes within a membrane.

An exemplary open structure is shown in FIG. 4A. The open structure 110 of a membrane may extend into the membrane at least 1%, at least 10%, at least 20%, at least 25%, at least 30%, at least 40%, or at least 50%, at least 60%, at least 80%, at least 90%, at least 99%, or within any range using the foregoing values as endpoints, such as 1% to 99%, 20% to 90%, or 25% to 80%, 30% to 60%, or 40% to 50% of the bipolar membrane composite thickness.

The average pore size of a porous structure may be measured and determined by scanning electron microscopy (SEM) imaging and/or measuring gas permeability under a relative vapor pressure. The average pore size may be determined by taking a cross section of a membrane, as seen in FIG. 3. The SEM image of the membrane shown in FIG. 3 is to scale according to the scale at the bottom of the image. Alternatively, the average pore size may be determined at the surface of a membrane layer, as seen in FIGS. 4A and 4B, both of which are also to scale images according to the scale at the bottom of each image. In some embodiments, the pore size of a membrane layer may be homogenous throughout the density of the membrane. In other embodiments, the pore size of a membrane layer may vary between cross-sections of the membrane layer.

The average pore size of the open structure may be 0.2 μm, 0.4 μm, 0.6 μm, 0.8 μm, to 1.0 μm, 2.0 μm, 3.0 μm, 5.0 μm, or within any range using the foregoing values as endpoints, such as 0.2 to 5.0 μm, 0.4 to 3.0 μm, 0.6 μm to 2.0 μm, or 0.8 to 1.0 μm.

In one embodiment, the pore characteristics, such as the thickness, pore distribution, and average pore size, of the open structure of the first membrane may be substantially identical to the pore characteristics of the open structure of the second membrane. In another embodiment, the pore characteristics of the open structure of the first membrane may be different than the pore characteristics of the open structure of the second membrane.

An exemplary tight structure is shown in FIG. 4B. The tight structure 120 of a membrane may extend into an amount of the total thickness of the membrane from least 1%, at least 10%, at least 20%, at least 30%, at least 40%, at least 50%, at least 70%, or within any range using the foregoing values as endpoints, such as 1% to 70%, 20% to 50%, or 30% to 40% of the total membrane thickness.

The average pore size of the tight structure may be 0.02 μm, 0.05 μm, 0.10 μm to 0.25 μm, 0.50 μm, 1.00 μm, or any range using the foregoing values as endpoints, such as 0.02 μm to 1.0 μm, 0.05 μm to 0.50 μm, or 0.10 μm to 0.25 μm.

In one embodiment, the pore characteristics, such as the thickness and average pore size, of the tight structure of the first membrane may be substantially identical to the pore characteristics of the tight structure of the second membrane. In another embodiment, the pore characteristics of the tight structure of the first membrane may be different than the pore characteristics of the tight structure of the second membrane.

The open structure of the first/second membrane may have a thickness at 0 % relative humidity (RH) from about 5 μm to 100 μm, about 5 μm to 90 μm, about 5 μm to 80 μm, about 5 μm 70 μm, about 5 μm to 60 μm, about 5 μm to 50 μm, about 5 μm to 40 μm, about 5 μm to 30 μm, about 5 μm to 20 μm, about 5 μm to 10 μm, or within any range encompassed by the foregoing. The ratio of the thickness of the open structure of the first/second membrane to thickness of the tight structure of the first/second membrane may be from 0.5, 1, 10 to 50, 70, 100, or any range using the foregoing as endpoints, such as 0.5 to 100, 1 to 70, or 10 to 50.

An exemplary membrane is shown in FIG. 4C, including both, a tight structure (FIG. 4B) and an open structure (FIG. 4A). The SEM image of the membrane in FIG. 4C is to scale according to the scale at the bottom of the image.

An exemplary pore diameter distribution of for a tight structure and an open structure is shown in FIG. 4D.

As seen in FIG. 1C, the bipolar membrane composite 100c may include an additional membrane 130. The additional membrane 130 may include a filled membrane or an inert layer, such as a single tight structure, a single open structure, or other microporous polymer structure configured to be impregnated with a catalyst. The additional membrane may be supported by at least one of a film, a tape, the first membrane, the second membrane, and another membrane. The additional membrane 130 may be optional for the bipolar membrane composite.

The additional membrane 130 may have a thickness at 0 % relative humidity (RH) of greater than 100 nm, greater than 200 nm, greater than 500 nm, greater than 1000 nm, greater than 1500 nm, or greater than 2000 nm, greater than 5000 nm, greater than 10,000 nm, or any range using the foregoing values as endpoints, such as 100 nm to 10,000 nm, 200 nm to 5000 nm, or 500 nm to 2000 nm, or 1000 nm to 1500 nm.

The bipolar membrane composite including the first membrane, the second membrane, and an additional membrane 130, may have a total thickness of, 10 μm, 20 μm, 30 μm, 40 μm, 50 μm to 70 μm, 80 μm, 100 μm, 150 μm, or 200 μm, or any range using the foregoing values as endpoints, such as 10 μm to 200 μm, 20 μm to 150 μm, 30 μm to 100 μm, 40 μm to 80 μm, or 50 μm to 70 μm.

The bipolar membrane composite may include ion exchange materials, an inert material, and a catalyst. Referring to FIGS. 1A-2T, an ion exchange material (IEM) 144 may be embedded or imbibed into at least one of the open and tight structures of the single, first, and second membrane. The IEM 144 may be embedded or imbibed. The IEM 144 may be embedded into the structures of the membranes partially or substantially, rendering the interior volume thereof substantially occlusive (i.e., the interior volume having structures that are characterized by low volume of voids and being highly impermeable to gases).

The IEM may be embedded into the open or tight structure of the membrane such that about 80% to 99.9%, 84% to 99.0%, 86% to 98%, 90% to 96%, or 92% to 94%, or any range encompassing the foregoing, of the volume of the structures 110, 120, of the first and second membrane 102a, 102b is occluded. For example, by filling greater than 90% of the interior volume of the structures 110, 120 of the first and second membrane 102a, 102b with the ion exchange material 144 substantial occlusion will occur, and the membrane will be characterized by Gurley numbers larger than 10000 s.

The IEM 144 may be securely adhered to the microporous polymer structures of the surfaces of the membrane, e.g., the fibrils and/or nodes of the microporous polymer structure.

The IEM 144 may be embedded into a membrane such that the concentration of the IEM is uniform throughout the membrane. In an alternative embodiment, the IEM 144 may be embedded into a membrane such that the concentration of the IEM is nonuniform throughout the membrane. An exemplary nonuniform concentration may include a layer of IEM 144 within the membrane. The IEM 144 may be embedded into a membrane such that a gradient of the IEM is created. The membrane with an IEM gradient may have varying concentrations of IEM across the membrane. Different structures, such as a tight structure or an open structure, of a membrane may have an IEM gradient.

In one exemplary embodiment, a membrane with an IEM gradient may have a higher concentration of IEM in a top portion of the membrane and a lower concentration of IEM in an opposite bottom portion of the membrane such that the concentration of IEM gradually decreases down the membrane from the top portion to the bottom portion. Alternatively, a membrane with an IEM gradient may have a higher concentration of IEM in a first side the membrane and a lower concentration of IEM in an opposing side of the membrane such that the concentration of IEM gradually decreases down the membrane from one side to the other

In another embodiment, a membrane with an IEM 144 gradient may have a lower concentration of IEM in both a top portion and an opposite bottom portion and a higher concentration of IEM in a middle portion of the membrane. Starting from the top of the membrane, the IEM concentration may gradually increase down the membrane toward a middle portion of the membrane. The IEM concentration may have a maximum concentration at the middle portion of the membrane. Moving down the membrane from the middle portion to the bottom portion, the concentration of IEM may decrease. Or conversely, the membrane may have a maximum concentration of IEM in the top and bottom portions and a minimum concentration of IEM in a middle portion.

In an alternative embodiment, at least one structure of the first and second membranes is embedded with an inert material instead of an IEM. The inert material is embedded such that about 1% to 20%, 2% to 15%, 3% to 10%, 4% to 8% or 5% to 6%, or any range encompassing the foregoing, of the volume of the structure 110, 120, of the first and second membrane 102a, 102b is occluded.

In some embodiments, part of the ion exchange material may exceed the volume of the first membrane and/or the second membrane.

Further, a catalyst 146 may be included in at least one structure of the single membrane 102, first membrane 102a, second membrane 102b, or the additional membrane 130. The catalyst may be embedded into a membrane such that the catalyst extends from an interface 140 between membranes into an amount of the thickness of the membrane of less than 20%, less than 15%, less than 10%, less than 5%, less than 2.5%, less than 1%, or within any range encompassed by the foregoing values, such as 1% to 20%, 2.5% to 15%, or 5% to 10%.

### B. Ion Exchange Material

A suitable ion exchange material may be dependent on the application in which the bipolar membrane composite is to be used. The ion exchange material preferably has an average ion exchange capacity from about 0.5 meq/g to about 5/0 meq/g, optionally about 1.0 meq/g to about 3.0 meq/g, optionally from about 1.5 meq/g to about 2.5 meq/g, or within any range encompassed by the foregoing. The ion exchange material may be chemically and thermally stable in the environment in which the bipolar membrane composite is to be used.

The ion exchange material may include a cation exchange material or an anion exchange material. In some embodiments, the ion exchange material includes a proton conducting polymer or cation exchange material. In some embodiments, the ion exchange material includes a hydroxide conducting polymer or anion exchange material. The ion exchange material may be selected from the group including perfluorocarboxylic acid polymers, perfluorophosphonic acid polymers, styrenic ion exchange polymers, fluorostyrenic ion exchange polymers, polyarylether ketone ion exchange polymers, polysulfone ion exchange polymers, bis(fluoroalkylsulfonyl)imides, (fluoroalkylsulfonyl)(fluorosulfonyl) imides, polyvinyl alcohol, polyethylene oxides, divinyl benzene, metal salts with or without a polymer and mixtures thereof. Examples of suitable commercially available polymers include Nafion® (E. I. DuPont de Nemours, Inc., Wilmington, Del., US), Flemion® (Asahi Glass Co. Ltd., Tokyo, JP), Aciplex® (Asahi Chemical Co. Ltd., Tokyo, JP), Aquivion® (SolvaySolexis S.P.A, Italy), and 3MTM (3M Innovative Properties Company, USA), Fumion FAA-3 (Fumatech, Germany), Fumion E600 (Fumatech, Germany), Fumion FSLA-725 (Fumatech, Germany), Sustainion (Dioxide Materials, USA), Pemion (Ionomr, Canada), and Aemion (Ionomr, Canada).

An embedded layer of the ion exchange material may have an embedded thickness/depth at 0 % RH in the range from about 0.5 μm to about 100 μm, from about 0.5 μm to about 50 μm, from about 0.5 μm to about 20 μm, from about 0.5 μm to about 10 μm, from about 0.5 μm to about 8 μm, or from about 2 μm to about 5 μm, or within any range encompassed by the foregoing.

### C. Inert Material and Layer

A suitable inert material may be dependent on the application of the bipolar membrane composite. The inert material may be an inert or inactive resin such as polypropylene, an inert binder, or any other inert media that may prevent ions in the acidified and basified flows from crossing over or may create a gap between anion exchange ionomers and cation exchange ionomers.

The bipolar membrane composite may include an inert layer such as a single tight structure, a single open structure, or other microporous polymer structure. Suitable inert layers may include battery separator membranes or materials that are used in battery separator membranes such a polyethylene (PE), expanded polyethylene (ePE), polypropylene, polyolefin, polytetrafluoroethylene (PTFE), expanded polytetrafluoroethylene (ePTFE), and polyvinylchloride (PVC).

### D. Catalyst

The bipolar membrane composite may include a catalyst, such as a water dissociation catalyst, embedded in at least one of the first membrane, the second membrane, and the additional membrane. The catalyst may cause an oxidation-reduction reaction when the catalyst comes in contact with a solution including water. The oxidation-reduction reaction may cause separation of anions and cations within the solution. The catalyst may include one or more of Pt, Ir, Ni, Co, Pd, Ti, Sn, Ta, Nb, Sb, Pb, Mn, Ru, Re, a metal oxide, graphene oxide, and mixtures thereof.

### E. Bipolar Membrane Composite Configuration and Assembly

The bipolar membrane composite may be assembled by embedding a first IEM, a second IEM, and the catalyst in the first, second, and additional membrane, and joining the first membrane, the second membrane, and, optionally, the additional membrane together. Each layer of the bipolar membrane composite may be joined together by suitable engagement mechanisms. The layers may be engaged by melting, gluing, laminating, or mechanical bonding such as paste processing.

The first and second membrane may be engaged such that there is a discernable interface with a measurable thickness between the two membranes. The thickness between the two membranes may incorporate a catalyst layer, an inert layer, a membrane, or another interfacial layer.

The first and second membrane may be engaged such that there is not a discernable interface between the two membranes such that the microstructures of the two membranes have joined in such a way as there is not a discernable interface between the two membranes. Effectively, the first and second membrane may be linked into a single membrane.

The bipolar membrane composite of the present disclosure may include the individual membrane layers in a plurality of configurations. The following five exemplary embodiments describe configurations of the bipolar membrane composite layers and the method of making each configuration.

As seen in FIG. 1A, a bipolar membrane composite 100a may include a first membrane 102a and a second membrane 102b each including an open structure 110a, 110b and a tight structure 120a, 120b. The first and second membranes may be oriented together such that the open structure 110a, 110b of each of the first and second membranes meet at an interface 140. The tight structure 120a of the first membrane 102a and the tight structure 120b of the second membrane 102b may be outwardly facing. In an alternative embodiment, shown in FIG. 1E, the first and second membranes may be joined together such that the open structure 110a, 110b of each of the first and second membranes are coupled to opposing sides of an additional membrane 130.

The bipolar membrane composite 100a may have a first ion exchange material 144a embedded into the tight structure 120a of the first membrane 102a to render the tight structure 120a at least partially occluded. The ion exchange material 144a may further be partially embedded into the open structure 110a of the first membrane 102a as well. A second ion exchange material 144b may be embedded into the tight structure 120b of the second membrane 102b to render the tight structure 120b at least partially occluded. The ion exchange material 144b may further be partially embedded into the open structure 110b of the second membrane 102b as well. A water dissociation catalyst 146a, 146b may be embedded into at least one of the open structure 110a of the first membrane 102a, the open structure 110b of the second membrane 102b, or an additional layer, such as the additional membrane 130, if present, as shown in FIG. 1E.

As seen in FIG. 1B, another embodiment of a bipolar membrane composite 100b may include a first membrane 102a and a second membrane 102b each including an open structure 110a, 110b and a tight structure 120a, 120b. The first and second membranes may be joined together such that the tight structure 120a, 120b of each of the first and second membranes engage at an interface 140. The open structure 110a of the first membrane 102a and the open structure 110b of the second membrane 102b may be outwardly facing.

The bipolar membrane composite 100b may have a first ion exchange material 144a embedded into the open structure 110a of the first membrane 102a. The ion exchange material 144a may further be partially embedded into the tight structure 120a of the first membrane 102a as well. A second ion exchange material 144b may be embedded into the open structure 110b of the second membrane 102b. The ion exchange material 144b may further be partially embedded into the tight structure 120b of the second membrane 102b as well. A water dissociation catalyst 146a, 146b may be embedded into at least one of the tight structure 120a of the first membrane 102a and the tight structure 120b of the second membrane 102b.

In yet another embodiment, a bipolar membrane composite 100c, as seen in FIG. 1C, may include a first membrane 102a and a second membrane 102b each including an open structure 110a, 110b and a tight structure 120a, 120b. The first and second membranes may be joined together such that the tight structure 120a, 120b of each of the first and second membranes are coupled to opposing sides of an additional membrane 130. The open structure 110a of the first membrane 102a and the open structure 110b of the second membrane 102b may be outwardly facing.

A first method of forming bipolar membrane composite 100c includes embedding a water dissociation catalyst 146 into an additional membrane 130. Once the additional membrane is embedded with the water dissociation catalyst, the first membrane, the second membrane, and the additional membrane may be joined using a suitable engagement method. A first ion exchange material 144a may then be embedded into the open structure 110a and/or the tight structure 120a of the first membrane 102a and/or the additional membrane 130 and a second ion exchange material 144b may be embedded into the open structure 110b and/or the tight structure 120b of the second membrane 102b and/or the additional membrane 130.

A second method of forming bipolar membrane composite 100c includes imbedding a water dissociation catalyst 146 into an additional membrane 130. A first ion exchange material 144a may be embedded into the open structure 110a and/or the tight structure 120a of the first membrane 102a and a second ion exchange material 144b may be embedded into the open structure 110b and/or the tight structure 120b of the second membrane 102b. Once the membranes have been embedded with the water dissociation catalyst and the ion exchange material, the first membrane, the second membrane, and the additional membrane may be joined using a suitable engagement method.

In a variation of bipolar membrane composite 100c, a bipolar membrane composite 100e, as seen in FIG. 1E, may include a first membrane 102a and a second membrane 102b each including an open structure 110a, 110b and a tight structure 120a, 120b. The first and second membranes may be joined together such that the open structure 110a, 110b of each of the first and second membranes are coupled to opposing sides of an additional membrane 130. The tight structure 120a of the first membrane 102a and the tight structure 120b of the second membrane 102b may be outwardly facing.

A first method of forming bipolar membrane composite 100e may include embedding a water dissociation catalyst 146 into an additional membrane 130. Once the additional membrane is embedded with the water dissociation catalyst, the first membrane, the second membrane, and the additional membrane may be joined using a suitable engagement method. A first ion exchange material 144a may then be embedded into the tight structure 120a and/or the open structure 110a of the first membrane 102a and/or the additional membrane 130 and a second ion exchange material 144b may be embedded into the tight structure 120b and/or the open structure 110b of the second membrane 102b and/or the additional membrane 130.

A second method of forming bipolar membrane composite 100e may include imbedding a water dissociation catalyst 146 into an additional membrane 130. A first ion exchange material 144a may be embedded into the tight structure 120a and/or the open structure 110a of the first membrane 102a and a second ion exchange material 144b may be embedded into the tight structure 120b and/or the open structure 110b of the second membrane 102b. Once the membranes have been embedded with the water dissociation catalyst and the ion exchange material, the first membrane, the second membrane, and the additional membrane may be joined using a suitable engagement method.

In another exemplary embodiment, as seen in FIGS. 1D and 1G, a bipolar membrane composite 100d, 100g may include a first membrane 102a and a second membrane 102b each including an open structure 110a, 110b. The first and second membranes may be joined together such that the open structures 110a, 110b of each of the first and second membranes are coupled to opposing sides of an additional membrane. The additional membrane may include a tight structure 120, as seen in FIG. 1D. Alternatively, the additional membrane may be a filled membrane 130, as seen in FIG. 1G.

The bipolar membrane composite 100d, 100g may have a first ion exchange material 144a embedded into the open structure 110a of the first membrane 102a. A second ion exchange material 144b may be embedded into the open structure 110b of the second membrane 102b. A water dissociation catalyst 146 may be embedded into the additional membrane 120, 130. An ion exchange material 144a, 144b may also be embedded in the additional membrane.

In another exemplary embodiment, as seen in FIG. 1F, a bipolar membrane composite 100f may include a first membrane 102a and a second membrane 102b. The first membrane 102a may include an open structure 110a and a tight structure 120a. The second membrane 102b may include one of an open structure 110b and a tight structure 120b. The first and second membranes may be joined together such that the tight structure 120a of the first membrane 102a engages one of the open structure 110b and tight structure 120b of the second membrane 102b at an interface 140.

The bipolar membrane composite 100f may have a first ion exchange material 144a embedded into at least one of the open structure 110a and the tight structure 120a of the first membrane 102a. A second ion exchange material 144b may be embedded into the one of the open structure 110b and tight structure 120b of the second membrane 102b. A water dissociation catalyst 146 may be embedded into at least one of the tight structure 120a of the first membrane 102a, the open structure 110a of the first membrane 102a, and the open structure 110b/120b of the second membrane 102b.

In another exemplary embodiment, as seen in FIG. 1H, a bipolar membrane composite 100h may include a first membrane 102a and a second membrane 102b. The first membrane 102a may include an open structure 110a. The second membrane 102b may include an open structure 110b. The first and second membranes may be joined together such the open structure 110a of the first membrane 102a engages the open structure 110b of the second membrane 102b at an interface 140.

The bipolar membrane composite 100h may have a first ion exchange material 144a embedded into the open structure 110a of the first membrane 102a. A second ion exchange material 144b may be embedded into the open structure 110b of the second membrane 102b. A water dissociation catalyst 146 may be at least partially embedded into at least one of the open structure 110a of the first membrane and the open structure 110b of the second membrane 102b.

In another exemplary embodiment, as seen in FIG. 1I, a bipolar membrane composite 100i may include a single membrane 102. Membrane 102 may include a first open structure 110a, an opposing second open structure 110b, and a tight structure 120 between the first open structure 110a and the second open structure 110b.

The bipolar membrane composite 100i may have a first ion exchange material 144a embedded into the first open structure 110a and a second ion exchange material 144b embedded into the second open structure 110b. At least one of the first ion exchange material 144a and the second ion exchange material 144b may be at least partially embedded into the tight structure 120. A water dissociation catalyst 146 may be at least partially embedded into the tight structure 120 of the membrane 100i.

In another exemplary embodiment, as seen in FIG. 1J, a bipolar membrane composite 100j may include a first membrane 102a, a second membrane 102b, and an additional membrane 130. The first membrane 102a may include an open structure 110a and a tight structure 120a. The second membrane 102b may include an open structure 110b. The first and second membranes may be joined together such that the tight structure 120a of the first membrane 102a and the open structure 110b of the second membrane 102b are coupled to opposing sides of the additional membrane 130. The additional membrane 130 may include a tight structure, a filled membrane, or an inert layer, such as a single tight structure, a single open structure, or other microporous polymer structure.

The bipolar membrane composite 100j may have a first ion exchange material 144a embedded into the open structure 110a of the first membrane 102a. The first ion exchange material 144a may also be at least partially embedded into the tight structure 120a of the first membrane 102a. A second ion exchange material 144b may be embedded into the open structure 110b of the second membrane 102b. A water dissociation catalyst 146 may be embedded into at least one of the tight structure 120a of the first membrane 102a and the additional membrane 130. An ion exchange material 144a, 144b may also be embedded in the additional membrane.

In another exemplary embodiment, as seen in FIG. 1K, a bipolar membrane 100k may include a first membrane 102a, a second membrane 102b, and an additional membrane 130. The first membrane 102a may include an open structure 110. The second membrane 102b may include a tight structure 120. The additional membrane 130 may be between the open structure 110 and the tight structure 120. The additional membrane 130 may include a tight structure, a filled membrane, or an inert layer, such as a single tight structure, a single open structure, or other microporous polymer structure.

The bipolar membrane 100k may have a first ion exchange material 144a embedded into the open structure 110 and a second ion exchange material 144b embedded into the tight structure 120. At least one of the first ion exchange material 144a and the second ion exchange material 144b may be at least partially embedded into the additional membrane 130. A water dissociation catalyst 146 may be at least partially embedded into the additional membrane 130 of membrane 100k.

In another exemplary embodiment, as seen in FIG. 1L, a bipolar membrane 1001 may include a first membrane 102a, a second membrane 102b, and an additional membrane 130. The first membrane 102a may include an open structure 110 and a tight structure 120a. The second membrane 102b may include a tight structure 120b. The first and second membranes may be joined together such that the tight structure 120a of the first membrane 102a and the tight structure 120b of the second membrane 102b are coupled to opposing sides of the additional membrane 130. The additional membrane 130 may include a tight structure, a filled membrane, or an inert layer, such as a single tight structure, a single open structure, or other microporous polymer structure.

The bipolar membrane 1001 may have a first ion exchange material 144a embedded into the open structure 110 of the first membrane 102a. The first ion exchange material 144a may also be at least partially embedded into the tight structure 120a of the first membrane 102a. A second ion exchange material 144b embedded into the tight structure 120b. At least one of the first ion exchange material 144a and the second ion exchange material 144b may be at least partially embedded into the additional membrane 130. A water dissociation catalyst 146 may be at least partially embedded into the additional membrane 130 of membrane 100k.

As seen in FIG. 1M, a bipolar membrane composite 100m may include a first membrane 102a and a second membrane 102b each including an open structure 110a, 110b and a tight structure 120a, 120b. The first and second membranes may be oriented together such that the open structure 110a, 110b of each of the first and second membranes meet at an interface 140. The tight structure 120a of the first membrane 102a and the tight structure 120b of the second membrane 102b may be outwardly facing. In an alternative embodiment, shown in FIG. 1Q, the first and second membranes may be joined together such that the open structure 110a, 110b of each of the first and second membranes are coupled to opposing sides of an additional membrane 130.

The bipolar membrane composite 100a may have a first ion exchange material 144a embedded into the tight structure 120a of the first membrane 102a to render the tight structure 120a at least partially occluded. The ion exchange material 144a may further be partially embedded into the open structure 110a of the first membrane 102a as well. A second ion exchange material 144b may be embedded into the tight structure 120b of the second membrane 102b to render the tight structure 120b at least partially occluded. The ion exchange material 144b may further be partially embedded into the open structure 110b of the second membrane 102b as well. A water dissociation catalyst 146a, 146b may be embedded into at least one of the open structure 110a of the first membrane 102a, the open structure 110b of the second membrane 102b, or an additional layer, such as the additional membrane 130, if present, as shown in FIG. 1Q. Part of the ion exchange material 144a may exceed the volume of the first membrane 102a, forming a buttercoat 148a, wherein the tight structure 120a is between the buttercoat 148a and the open structure 110a. Part of the ion exchange material 144b may exceed the volume of the first membrane 102b, forming a buttercoat 148b, wherein the tight structure 120b is between the buttercoat 148b and the open structure 110b.

As seen in FIG. 1N, another embodiment of a bipolar membrane composite 100n may include a first membrane 102a and a second membrane 102b each including an open structure 110a, 110b and a tight structure 120a, 120b. The first and second membranes may be joined together such that the tight structure 120a, 120b of each of the first and second membranes engage at an interface 140. The open structure 110a of the first membrane 102a and the open structure 110b of the second membrane 102b may be outwardly facing.

The bipolar membrane composite 100n may have a first ion exchange material 144a embedded into the open structure 110a of the first membrane 102a. The ion exchange material 144a may further be partially embedded into the tight structure 120a of the first membrane 102a as well. A second ion exchange material 144b may be embedded into the open structure 110b of the second membrane 102b. The ion exchange material 144b may further be partially embedded into the tight structure 120b of the second membrane 102b as well. A water dissociation catalyst 146a, 146b may be embedded into at least one of the tight structure 120a of the first membrane 102a and the tight structure 120b of the second membrane 102b. Part of the ion exchange material 144a may exceed the volume of the first membrane 102a, forming a buttercoat 148a, wherein the open structure 110a is between the buttercoat 148a and the tight structure 120a. Part of the ion exchange material 144b may exceed the volume of the first membrane 102b, forming a buttercoat 148b, wherein the open structure 110b is between the buttercoat 148b and the tight structure 120b.

In yet another embodiment, a bipolar membrane composite 1000, as seen in FIG. 1O, may include a first membrane 102a and a second membrane 102b each including an open structure 110a, 110b and a tight structure 120a, 120b. The first and second membranes may be joined together such that the tight structure 120a, 120b of each of the first and second membranes are coupled to opposing sides of an additional membrane 130. The open structure 110a of the first membrane 102a and the open structure 110b of the second membrane 102b may be outwardly facing. Part of the ion exchange material 144a may exceed the volume of the first membrane 102a, forming a buttercoat 148a, wherein the open structure 110a is between the buttercoat 148a and the tight structure 120a. Part of the ion exchange material 144b may exceed the volume of the first membrane 102b, forming a buttercoat 148b, wherein the open structure 110b is between the buttercoat 148b and the tight structure 120b.

A first method of forming bipolar membrane composite 1000 includes embedding a water dissociation catalyst 146 into an additional membrane 130. Once the additional membrane is embedded with the water dissociation catalyst, the first membrane, the second membrane, and the additional membrane may be joined using a suitable engagement method. A first ion exchange material 144a may then be embedded into the open structure 110a and/or the tight structure 120a of the first membrane 102a and/or the additional membrane 130 and a second ion exchange material 144b may be embedded into the open structure 110b and/or the tight structure 120b of the second membrane 102b and/or the additional membrane 130.

A second method of forming bipolar membrane composite 1000 includes imbedding a water dissociation catalyst 146 into an additional membrane 130. A first ion exchange material 144a may be embedded into the open structure 110a and/or the tight structure 120a of the first membrane 102a and a second ion exchange material 144b may be embedded into the open structure 110b and/or the tight structure 120b of the second membrane 102b. Once the membranes have been embedded with the water dissociation catalyst and the ion exchange material, the first membrane, the second membrane, and the additional membrane may be joined using a suitable engagement method.

In a variation of bipolar membrane composite 1000, a bipolar membrane composite 100q, as seen in FIG. 1Q, may include a first membrane 102a and a second membrane 102b each including an open structure 110a, 110b and a tight structure 120a, 120b. The first and second membranes may be joined together such that the open structure 110a, 110b of each of the first and second membranes are coupled to opposing sides of an additional membrane 130. The tight structure 120a of the first membrane 102a and the tight structure 120b of the second membrane 102b may be outwardly facing. Part of the ion exchange material 144a may exceed the volume of the first membrane 102a, forming a buttercoat 148a, wherein the tight structure 120a is between the buttercoat 148a and the open structure 110a. Part of the ion exchange material 144b may exceed the volume of the first membrane 102b, forming a buttercoat 148b, wherein the tight structure 120b is between the buttercoat 148b and the open structure 110b.

A first method of forming bipolar membrane composite 1000 may include embedding a water dissociation catalyst 146 into an additional membrane 130. Once the additional membrane is embedded with the water dissociation catalyst, the first membrane, the second membrane, and the additional membrane may be joined using a suitable engagement method. A first ion exchange material 144a may then be embedded into the tight structure 120a and/or the open structure 110a of the first membrane 102a and/or the additional membrane 130 and a second ion exchange material 144b may be embedded into the tight structure 120b and/or the open structure 110b of the second membrane 102b and/or the additional membrane 130.

A second method of forming bipolar membrane composite 1000 may include imbedding a water dissociation catalyst 146 into an additional membrane 130. A first ion exchange material 144a may be embedded into the tight structure 120a and/or the open structure 110a of the first membrane 102a and a second ion exchange material 144b may be embedded into the tight structure 120b and/or the open structure 110b of the second membrane 102b. Once the membranes have been embedded with the water dissociation catalyst and the ion exchange material, the first membrane, the second membrane, and the additional membrane may be joined using a suitable engagement method.

In another exemplary embodiment, as seen in FIGS. 1P and 1S, a bipolar membrane composite 100p, 100s may include a first membrane 102a and a second membrane 102b each including an open structure 110a, 110b. The first and second membranes may be joined together such that the open structures 110a, 110b of each of the first and second membranes are coupled to opposing sides of an additional membrane. The additional membrane may include a tight structure 120, as seen in FIG. 1P. Alternatively, the additional membrane may be a filled membrane 130, as seen in FIG. 1S.

The bipolar membrane composite 100p, 100s may have a first ion exchange material 144a embedded into the open structure 110a of the first membrane 102a. A second ion exchange material 144b may be embedded into the open structure 110b of the second membrane 102b. A water dissociation catalyst 146 may be embedded into the additional membrane 120, 130. An ion exchange material 144a, 144b may also be embedded in the additional membrane.

For the bipolar membrane composite 100p, part of the ion exchange material 144a may exceed the volume of the first membrane 102a, forming a buttercoat 148a, wherein the open structure 110a is between the buttercoat 148a and the additional membrane 120. Part of the ion exchange material 144b may exceed the volume of the first membrane 102b, forming a buttercoat 148b, wherein the open structure 110b is between the buttercoat 148b and the additional membrane 120. For the bipolar membrane composite 100s, part of the ion exchange material 144a may exceed the volume of the first membrane 102a, forming a buttercoat 148a, wherein the open structure 110a is between the buttercoat 148a and the filled membrane 130. Part of the ion exchange material 144b may exceed the volume of the first membrane 102b, forming a buttercoat 148b, wherein the open structure 110b is between the buttercoat 148b and the filled membrane 130.

In another exemplary embodiment, as seen in FIG. 1R, a bipolar membrane composite 100r may include a first membrane 102a and a second membrane 102b. The first membrane 102a may include an open structure 110a and a tight structure 120a. The second membrane 102b may include one of an open structure 110b and a tight structure 120b. The first and second membranes may be joined together such that the tight structure 120a of the first membrane 102a engages one of the open structure 110b and tight structure 120b of the second membrane 102b at an interface 140.

The bipolar membrane composite 100r may have a first ion exchange material 144a embedded into at least one of the open structure 110a and the tight structure 120a of the first membrane 102a. A second ion exchange material 144b may be embedded into the one of the open structure 110b and tight structure 120b of the second membrane 102b. A water dissociation catalyst 146 may be embedded into at least one of the tight structure 120a of the first membrane 102a, the open structure 110a of the first membrane 102a, and the open structure 110b/120b of the second membrane 102b. Part of the ion exchange material 144a may exceed the volume of the first membrane 102a, forming a buttercoat 148a, wherein the open structure 110a is between the buttercoat 148a and the tight structure 120a. Part of the ion exchange material 144b may exceed the volume of the first membrane 102b, forming a buttercoat 148b, wherein one of the open structure 110b and tight structure 120b is between the buttercoat 148b and the tight structure 120a.

In another exemplary embodiment, as seen in FIG. 1T, a bipolar membrane composite 100t may include a first membrane 102a and a second membrane 102b. The first membrane 102a may include an open structure 110a. The second membrane 102b may include an open structure 110b. The first and second membranes may be joined together such the open structure 110a of the first membrane 102a engages the open structure 110b of the second membrane 102b at an interface 140.

The bipolar membrane composite 100t may have a first ion exchange material 144a embedded into the open structure 110a of the first membrane 102a. A second ion exchange material 144b may be embedded into the open structure 110b of the second membrane 102b. A water dissociation catalyst 146 may be at least partially embedded into at least one of the open structure 110a of the first membrane and the open structure 110b of the second membrane 102b. Part of the ion exchange material 144a may exceed the volume of the first membrane 102a, forming a buttercoat 148a, wherein the open structure 110a is between the buttercoat 148a and the interface 140. Part of the ion exchange material 144b may exceed the volume of the first membrane 102b, forming a buttercoat 148b, wherein the open structure 110b is between the buttercoat 148b and the interface 140.

In another exemplary embodiment, as seen in FIG. 1U, a bipolar membrane composite 100u may include a single membrane 102. Membrane 102 may include a first open structure 110a, an opposing second open structure 110b, and a tight structure 120 between the first open structure 110a and the second open structure 110b.

The bipolar membrane composite 100u may have a first ion exchange material 144a embedded into the first open structure 110a and a second ion exchange material 144b embedded into the second open structure 110b. At least one of the first ion exchange material 144a and the second ion exchange material 144b may be at least partially embedded into the tight structure 120. A water dissociation catalyst 146 may be at least partially embedded into the tight structure 120 of the membrane 100i. Part of the ion exchange material 144a may exceed the volume of membrane 102, forming a buttercoat 148a and 148b, wherein the open structure 110a is between buttercoat 148a and tight structure 120, and wherein the open structure 110b is between buttercoat 148b and tight structure 120.

In another exemplary embodiment, as seen in FIG. 1V, a bipolar membrane composite 100v may include a first membrane 102a, a second membrane 102b, and an additional membrane 130. The first membrane 102a may include an open structure 110a and a tight structure 120a. The second membrane 102b may include an open structure 110b. The first and second membranes may be joined together such that the tight structure 120a of the first membrane 102a and the open structure 110b of the second membrane 102b are coupled to opposing sides of the additional membrane 130. The additional membrane 130 may include a tight structure, a filled membrane, or an inert layer, such as a single tight structure, a single open structure, or other microporous polymer structure.

The bipolar membrane composite 100v may have a first ion exchange material 144a embedded into the open structure 110a of the first membrane 102a. The first ion exchange material 144a may also be at least partially embedded into the tight structure 120a of the first membrane 102a. A second ion exchange material 144b may be embedded into the open structure 110b of the second membrane 102b. A water dissociation catalyst 146 may be embedded into at least one of the tight structure 120a of the first membrane 102a and the additional membrane 130. An ion exchange material 144a, 144b may also be embedded in the additional membrane. Part of the ion exchange material 144a may exceed the volume of the first membrane 102a, forming a buttercoat 148a, wherein the open structure 110a is between the buttercoat 148a and the tight structure 120a. Part of the ion exchange material 144b may exceed the volume of the first membrane 102b, forming a buttercoat 148b, wherein the open structure 110b is between the buttercoat 148b and the additional membrane 130.

In another exemplary embodiment, as seen in FIG. 1W, a bipolar membrane 100w may include a first membrane 102a, a second membrane 102b, and an additional membrane 130. The first membrane 102a may include an open structure 110. The second membrane 102b may include a tight structure 120. The additional membrane 130 may be between the open structure 110 and the tight structure 120. The additional membrane 130 may include a tight structure, a filled membrane, or an inert layer, such as a single tight structure, a single open structure, or other microporous polymer structure.

The bipolar membrane 100w may have a first ion exchange material 144a embedded into the open structure 110 and a second ion exchange material 144b embedded into the tight structure 120. At least one of the first ion exchange material 144a and the second ion exchange material 144b may be at least partially embedded into the additional membrane 130. A water dissociation catalyst 146 may be at least partially embedded into the additional membrane 130 of membrane 100k. Part of the ion exchange material 144a may exceed the volume of the first membrane 102a, forming a buttercoat 148a, wherein the open structure 110 is between the buttercoat 148a and the additional membrane 130. Part of the ion exchange material 144b may exceed the volume of the first membrane 102b, forming a buttercoat 148b, wherein the tight structure 120 is between the buttercoat 148b and the additional membrane 130.

In another exemplary embodiment, as seen in FIG. 1X, a bipolar membrane 100x may include a first membrane 102a, a second membrane 102b, and an additional membrane 130. The first membrane 102a may include an open structure 110 and a tight structure 120a. The second membrane 102b may include a tight structure 120b. The first and second membranes may be joined together such that the tight structure 120a of the first membrane 102a and the tight structure 120b of the second membrane 102b are coupled to opposing sides of the additional membrane 130. The additional membrane 130 may include a tight structure, a filled membrane, or an inert layer, such as a single tight structure, a single open structure, or other microporous polymer structure.

The bipolar membrane 100x may have a first ion exchange material 144a embedded into the open structure 110 of the first membrane 102a. The first ion exchange material 144a may also be at least partially embedded into the tight structure 120a of the first membrane 102a. A second ion exchange material 144b embedded into the tight structure 120b. At least one of the first ion exchange material 144a and the second ion exchange material 144b may be at least partially embedded into the additional membrane 130. A water dissociation catalyst 146 may be at least partially embedded into the additional membrane 130 of membrane 100k. Part of the ion exchange material 144a may exceed the volume of the first membrane 102a, forming a buttercoat 148a, wherein the open structure 110 is between the buttercoat 148a and the tight structure 120a. Part of the ion exchange material 144b may exceed the volume of the first membrane 102b, forming a buttercoat 148b, wherein the tight structure 120b is between the buttercoat 148b and the additional membrane 130.

As seen in FIG. 2A, a bipolar membrane composite 100-2a may include a first membrane 102a and a second membrane 102b each including an open structure 110a, 110b and a tight structure 120a, 120b. The first and second membranes may be oriented together such that the open structure 110a, 110b of each of the first and second membranes meet at an interface 140. The tight structure 120a of the first membrane 102a and the tight structure 120b of the second membrane 102b may be outwardly facing. In an alternative embodiment, shown in FIG. 2D, the first and second membranes may be joined together such that the open structure 110a, 110b of each of the first and second membranes are coupled to opposing sides of an additional membrane 130.

The bipolar membrane composite 100-2a may have a first ion exchange material 144a embedded into the tight structure 120a of the first membrane 102a to render the tight structure 120a at least partially occluded. The ion exchange material 144a may further be partially embedded into the open structure 110a of the first membrane 102a as well. A second ion exchange material 144b may be embedded into the tight structure 120b of the second membrane 102b to render the tight structure 120b at least partially occluded. The ion exchange material 144b may further be partially embedded into the open structure 110b of the second membrane 102b as well. A water dissociation catalyst 146a, 146b may be embedded into at least one of the open structure 110a of the first membrane 102a, the open structure 110b of the second membrane 102b, or an additional layer, such as the additional membrane 130, if present, as shown in FIG. 2D. Part of the ion exchange material 144a may exceed the volume of the first membrane 102a, forming a buttercoat 148a, wherein the buttercoat 148a is between the interface 140 and the open structure 110a. Part of the ion exchange material 144b may exceed the volume of the first membrane 102b, forming a buttercoat 148b, wherein the buttercoat 148b is between the interface 140 and the open structure 110b.

As seen in FIG. 2B, another embodiment of a bipolar membrane composite 100-2b may include a first membrane 102a and a second membrane 102b each including an open structure 110a, 110b and a tight structure 120a, 120b. The first and second membranes may be joined together such that the tight structure 120a, 120b of each of the first and second membranes engage at an interface 140. The open structure 110a of the first membrane 102a and the open structure 110b of the second membrane 102b may be outwardly facing.

The bipolar membrane composite 100-2b may have a first ion exchange material 144a embedded into the open structure 110a of the first membrane 102a. The ion exchange material 144a may further be partially embedded into the tight structure 120a of the first membrane 102a as well. A second ion exchange material 144b may be embedded into the open structure 110b of the second membrane 102b. The ion exchange material 144b may further be partially embedded into the tight structure 120b of the second membrane 102b as well. A water dissociation catalyst 146a, 146b may be embedded into at least one of the tight structure 120a of the first membrane 102a and the tight structure 120b of the second membrane 102b. Part of the ion exchange material 144a may exceed the volume of the first membrane 102a, forming a buttercoat 148a, wherein the buttercoat 148a is between the interface 140 and the tight structure 120a. Part of the ion exchange material 144b may exceed the volume of the first membrane 102b, forming a buttercoat 148b, wherein the buttercoat 148b is between the interface 140 and the tight structure 120b.

In yet another embodiment, a bipolar membrane composite 100-2c, as seen in FIG. 2C, may include a first membrane 102a and a second membrane 102b each including an open structure 110a, 110b and a tight structure 120a, 120b. The first and second membranes may be joined together such that the tight structure 120a, 120b of each of the first and second membranes are coupled to opposing sides of an additional membrane 130. The open structure 110a of the first membrane 102a and the open structure 110b of the second membrane 102b may be outwardly facing. Part of the ion exchange material 144a may exceed the volume of the first membrane 102a, forming a buttercoat 148a, wherein the buttercoat 148a is between the additional membrane 130 and the tight structure 120a. Part of the ion exchange material 144b may exceed the volume of the first membrane 102b, forming a buttercoat 148b, wherein the buttercoat 148b is between the additional membrane 130 and the tight structure 120b.

A first method of forming bipolar membrane composite 100-2c includes embedding a water dissociation catalyst 146 into an additional membrane 130. Once the additional membrane is embedded with the water dissociation catalyst, the first membrane, the second membrane, and the additional membrane may be joined using a suitable engagement method. A first ion exchange material 144a may then be embedded into the open structure 110a and/or the tight structure 120a of the first membrane 102a and/or the additional membrane 130 and a second ion exchange material 144b may be embedded into the open structure 110b and/or the tight structure 120b of the second membrane 102b and/or the additional membrane 130.

A second method of forming bipolar membrane composite 100-2c includes imbedding a water dissociation catalyst 146 into an additional membrane 130. A first ion exchange material 144a may be embedded into the open structure 110a and/or the tight structure 120a of the first membrane 102a and a second ion exchange material 144b may be embedded into the open structure 110b and/or the tight structure 120b of the second membrane 102b. Once the membranes have been embedded with the water dissociation catalyst and the ion exchange material, the first membrane, the second membrane, and the additional membrane may be joined using a suitable engagement method.

In a variation of bipolar membrane composite 100-2c, a bipolar membrane composite 100-2d, as seen in FIG. 2D, may include a first membrane 102a and a second membrane 102b each including an open structure 110a, 110b and a tight structure 120a, 120b. The first and second membranes may be joined together such that the open structure 110a, 110b of each of the first and second membranes are coupled to opposing sides of an additional membrane 130. The tight structure 120a of the first membrane 102a and the tight structure 120b of the second membrane 102b may be outwardly facing. Part of the ion exchange material 144a may exceed the volume of the first membrane 102a, forming a buttercoat 148a, wherein the buttercoat 148a is between the additional membrane 130 and the open structure 110a. Part of the ion exchange material 144b may exceed the volume of the first membrane 102b, forming a buttercoat 148b, wherein the buttercoat 148b is between the additional membrane 130 and the open structure 110b.

A first method of forming bipolar membrane composite 100-2d may include embedding a water dissociation catalyst 146 into an additional membrane 130. Once the additional membrane is embedded with the water dissociation catalyst, the first membrane, the second membrane, and the additional membrane may be joined using a suitable engagement method. A first ion exchange material 144a may then be embedded into the tight structure 120a and/or the open structure 110a of the first membrane 102a and/or the additional membrane 130 and a second ion exchange material 144b may be embedded into the tight structure 120b and/or the open structure 110b of the second membrane 102b and/or the additional membrane 130.

A second method of forming bipolar membrane composite 100-2d may include imbedding a water dissociation catalyst 146 into an additional membrane 130. A first ion exchange material 144a may be embedded into the tight structure 120a and/or the open structure 110a of the first membrane 102a and a second ion exchange material 144b may be embedded into the tight structure 120b and/or the open structure 110b of the second membrane 102b. Once the membranes have been embedded with the water dissociation catalyst and the ion exchange material, the first membrane, the second membrane, and the additional membrane may be joined using a suitable engagement method.

In another exemplary embodiment, as seen in FIG. 2E, a bipolar membrane composite 100-2e may include a first membrane 102a and a second membrane 102b. The first membrane 102a may include an open structure 110a and a tight structure 120a. The second membrane 102b may include one of an open structure 110b and a tight structure 120b. The first and second membranes may be joined together such that the tight structure 120a of the first membrane 102a engages one of the open structure 110b and tight structure 120b of the second membrane 102b at an interface 140.

The bipolar membrane composite 100-2e may have a first ion exchange material 144a embedded into at least one of the open structure 110a and the tight structure 120a of the first membrane 102a. A second ion exchange material 144b may be embedded into the one of the open structure 110b and tight structure 120b of the second membrane 102b. A water dissociation catalyst 146 may be embedded into at least one of the tight structure 120a of the first membrane 102a, the open structure 110a of the first membrane 102a, and the open structure 110b/120b of the second membrane 102b. Part of the ion exchange material 144a may exceed the volume of the first membrane 102a, forming a buttercoat 148a, wherein the buttercoat 148a is between the tight structure 120a and one of the open structure 110b and the tight structure 120b. Part of the ion exchange material 144b may exceed the volume of the second membrane 102b, forming a buttercoat 148b, wherein the buttercoat 148b is between the tight structure 120a and one of the open structure 110b and the tight structure 120b.

In another exemplary embodiment, as seen in FIG. 2F, a bipolar membrane composite 100-2f may include a first membrane 102a and a second membrane 102b each including an open structure 110a, 110b. The first and second membranes may be joined together such that the open structures 110a, 110b of each of the first and second membranes are coupled to opposing sides of an additional membrane. The additional membrane may be a filled membrane 130.

The bipolar membrane composite 100-2f may have a first ion exchange material 144a embedded into the open structure 110a of the first membrane 102a. A second ion exchange material 144b may be embedded into the open structure 110b of the second membrane 102b. A water dissociation catalyst 146 may be embedded into the additional membrane 120, 130. An ion exchange material 144a, 144b may also be embedded in the additional membrane. Part of the ion exchange material 144a may exceed the volume of the first membrane 102a, forming a buttercoat 148a, wherein the buttercoat 148a is between the additional membrane 130 and the open structure 110a. Part of the ion exchange material 144b may exceed the volume of the first membrane 102b, forming a buttercoat 148b, wherein the buttercoat 148b is between the additional membrane 130 and the open structure 110b.

In another exemplary embodiment, as seen in FIG. 2G, a bipolar membrane composite 100-2g may include a first membrane 102a and a second membrane 102b. The first membrane 102a may include an open structure 110a. The second membrane 102b may include an open structure 110b. The first and second membranes may be joined together such the open structure 110a of the first membrane 102a engages the open structure 110b of the second membrane 102b at an interface 140.

The bipolar membrane composite 100-2g may have a first ion exchange material 144a embedded into the open structure 110a of the first membrane 102a. A second ion exchange material 144b may be embedded into the open structure 110b of the second membrane 102b. A water dissociation catalyst 146 may be at least partially embedded into at least one of the open structure 110a of the first membrane and the open structure 110b of the second membrane 102b. Part of the ion exchange material 144a may exceed the volume of the first membrane 102a, forming a buttercoat 148a, wherein the buttercoat 148a is between the interface 140 and the open structure 110a. Part of the ion exchange material 144b may exceed the volume of the first membrane 102b, forming a buttercoat 148b, wherein the buttercoat 148b is between the interface 140 and the open structure 110b.

In another exemplary embodiment, as seen in FIG. 2H, a bipolar membrane composite 100-2h may include a first membrane 102a, a second membrane 102b, and an additional membrane 130. The first membrane 102a may include an open structure 110a and a tight structure 120a. The second membrane 102b may include an open structure 110b. The first and second membranes may be joined together such that the tight structure 120a of the first membrane 102a and the open structure 110b of the second membrane 102b are coupled to opposing sides of the additional membrane 130. The additional membrane 130 may include a tight structure, a filled membrane, or an inert layer, such as a single tight structure, a single open structure, or other microporous polymer structure.

The bipolar membrane composite 100-2h may have a first ion exchange material 144a embedded into the open structure 110a of the first membrane 102a. The first ion exchange material 144a may also be at least partially embedded into the tight structure 120a of the first membrane 102a. A second ion exchange material 144b may be embedded into the open structure 110b of the second membrane 102b. A water dissociation catalyst 146 may be embedded into at least one of the tight structure 120a of the first membrane 102a and the additional membrane 130. An ion exchange material 144a, 144b may also be embedded in the additional membrane. Part of the ion exchange material 144a may exceed the volume of the first membrane 102a, forming a buttercoat 148a, wherein the buttercoat 148a is between the additional membrane 130 and the tight structure 120a. Part of the ion exchange material 144b may exceed the volume of the first membrane 102b, forming a buttercoat 148b, wherein the buttercoat 148b is between the additional membrane 130 and the open structure 110b.

In another exemplary embodiment, as seen in FIG. 2I, a bipolar membrane 100-2i may include a first membrane 102a, a second membrane 102b, and an additional membrane 130. The first membrane 102a may include an open structure 110. The second membrane 102b may include a tight structure 120. The additional membrane 130 may be between the open structure 110 and the tight structure 120. The additional membrane 130 may include a tight structure, a filled membrane, or an inert layer, such as a single tight structure, a single open structure, or other microporous polymer structure.

The bipolar membrane 100-2i may have a first ion exchange material 144a embedded into the open structure 110 and a second ion exchange material 144b embedded into the tight structure 120. At least one of the first ion exchange material 144a and the second ion exchange material 144b may be at least partially embedded into the additional membrane 130. A water dissociation catalyst 146 may be at least partially embedded into the additional membrane 130 of membrane 100-2i. Part of the ion exchange material 144a may exceed the volume of the first membrane 102a, forming a buttercoat 148a, wherein the buttercoat 148a is between the additional membrane 130 and the open structure 110. Part of the ion exchange material 144b may exceed the volume of the first membrane 102b, forming a buttercoat 148b, wherein the buttercoat 148b is between the additional membrane 130 and the tight structure 120.

In another exemplary embodiment, as seen in FIG. 2J, a bipolar membrane 100-2j may include a first membrane 102a, a second membrane 102b, and an additional membrane 130. The first membrane 102a may include an open structure 110 and a tight structure 120a. The second membrane 102b may include a tight structure 120b. The first and second membranes may be joined together such that the tight structure 120a of the first membrane 102a and the tight structure 120b of the second membrane 102b are coupled to opposing sides of the additional membrane 130. The additional membrane 130 may include a tight structure, a filled membrane, or an inert layer, such as a single tight structure, a single open structure, or other microporous polymer structure.

The bipolar membrane 100-2j may have a first ion exchange material 144a embedded into the open structure 110 of the first membrane 102a. The first ion exchange material 144a may also be at least partially embedded into the tight structure 120a of the first membrane 102a. A second ion exchange material 144b embedded into the tight structure 120b. At least one of the first ion exchange material 144a and the second ion exchange material 144b may be at least partially embedded into the additional membrane 130. A water dissociation catalyst 146 may be at least partially embedded into the additional membrane 130 of membrane 100-2j. Part of the ion exchange material 144a may exceed the volume of the first membrane 102a, forming a buttercoat 148a, wherein the buttercoat 148a is between the additional membrane 130 and the tight structure 120a. Part of the ion exchange material 144b may exceed the volume of the first membrane 102b, forming a buttercoat 148b, wherein the buttercoat 148b is between the additional membrane 130 and the tight structure 120b.

As seen in FIG. 2K, a bipolar membrane composite 100-2k may include a first membrane 102a and a second membrane 102b each including an open structure 110a, 110b and a tight structure 120a, 120b. The first and second membranes may be oriented together such that the open structure 110a, 110b of each of the first and second membranes meet at an interface 140. The tight structure 120a of the first membrane 102a and the tight structure 120b of the second membrane 102b may be outwardly facing. In an alternative embodiment, shown in FIG. 2D, the first and second membranes may be joined together such that the open structure 110a, 110b of each of the first and second membranes are coupled to opposing sides of an additional membrane 130.

The bipolar membrane composite 100-2k may have a first ion exchange material 144a embedded into the tight structure 120a of the first membrane 102a to render the tight structure 120a at least partially occluded. The ion exchange material 144a may further be partially embedded into the open structure 110a of the first membrane 102a as well. A second ion exchange material 144b may be embedded into the tight structure 120b of the second membrane 102b to render the tight structure 120b at least partially occluded. The ion exchange material 144b may further be partially embedded into the open structure 110b of the second membrane 102b as well. A water dissociation catalyst 146a, 146b may be embedded into at least one of the open structure 110a of the first membrane 102a, the open structure 110b of the second membrane 102b, or an additional layer, such as the additional membrane 130, if present, as shown in FIG. 2D. Part of the ion exchange material 144a may exceed the volume of the first membrane 102a, forming a buttercoat 148a1, wherein the tight structure 120a is between the buttercoat 148a1 and the open structure 110a. Part of the ion exchange material 144b may exceed the volume of the first membrane 102b, forming a buttercoat 148b1, wherein the tight structure 120b is between the buttercoat 148b1 and the open structure 110b. Similarly, part of the ion exchange material 144a may exceed the volume of the first membrane 102a, forming a buttercoat 148a2, wherein the buttercoat 148a2 is between the interface 140 and the open structure 110a. Part of the ion exchange material 144b may exceed the volume of the first membrane 102b, forming a buttercoat 148b2, wherein the buttercoat 148b2 is between the interface 140 and the open structure 110b.

As seen in FIG. 2L, another embodiment of a bipolar membrane composite 100-2l may include a first membrane 102a and a second membrane 102b each including an open structure 110a, 110b and a tight structure 120a, 120b. The first and second membranes may be joined together such that the tight structure 120a, 120b of each of the first and second membranes engage at an interface 140. The open structure 110a of the first membrane 102a and the open structure 110b of the second membrane 102b may be outwardly facing.

The bipolar membrane composite 100-2l may have a first ion exchange material 144a embedded into the open structure 110a of the first membrane 102a. The ion exchange material 144a may further be partially embedded into the tight structure 120a of the first membrane 102a as well. A second ion exchange material 144b may be embedded into the open structure 110b of the second membrane 102b. The ion exchange material 144b may further be partially embedded into the tight structure 120b of the second membrane 102b as well. A water dissociation catalyst 146a, 146b may be embedded into at least one of the tight structure 120a of the first membrane 102a and the tight structure 120b of the second membrane 102b. Part of the ion exchange material 144a may exceed the volume of the first membrane 102a, forming a buttercoat 148a1, wherein the open structure 110a is between the buttercoat 148a1 and the tight structure 120a. Part of the ion exchange material 144b may exceed the volume of the first membrane 102b, forming a buttercoat 148b1, wherein the open structure 110b is between the buttercoat 148b1 and the tight structure 120b. Similarly, part of the ion exchange material 144a may exceed the volume of the first membrane 102a, forming a buttercoat 148a2, wherein the buttercoat 148a2 is between the interface 140 and the tight structure 120a. Part of the ion exchange material 144b may exceed the volume of the first membrane 102b, forming a buttercoat 148b2, wherein the buttercoat 148b2 is between the interface 140 and the tight structure 120b.

In yet another embodiment, a bipolar membrane composite 100-2m, as seen in FIG. 2M, may include a first membrane 102a and a second membrane 102b each including an open structure 110a, 110b and a tight structure 120a, 120b. The first and second membranes may be joined together such that the tight structure 120a, 120b of each of the first and second membranes are coupled to opposing sides of an additional membrane 130. The open structure 110a of the first membrane 102a and the open structure 110b of the second membrane 102b may be outwardly facing. Part of the ion exchange material 144a may exceed the volume of the first membrane 102a, forming a buttercoat 148a1, wherein the open structure 110a is between the buttercoat 148a1 and the tight structure 120a. Part of the ion exchange material 144b may exceed the volume of the first membrane 102b, forming a buttercoat 148b1, wherein the open structure 110b is between the buttercoat 148b1 and the tight structure 120b. Part of the ion exchange material 144a may exceed the volume of the first membrane 102a, forming a buttercoat 148a2, wherein the buttercoat 148a2 is between the additional membrane 130 and the tight structure 120a. Part of the ion exchange material 144b may exceed the volume of the first membrane 102b, forming a buttercoat 148b2, wherein the buttercoat 148b2 is between the additional membrane 130 and the tight structure 120b.

A first method of forming bipolar membrane composite 100-2m includes embedding a water dissociation catalyst 146 into an additional membrane 130. Once the additional membrane is embedded with the water dissociation catalyst, the first membrane, the second membrane, and the additional membrane may be joined using a suitable engagement method. A first ion exchange material 144a may then be embedded into the open structure 110a and/or the tight structure 120a of the first membrane 102a and/or the additional membrane 130 and a second ion exchange material 144b may be embedded into the open structure 110b and/or the tight structure 120b of the second membrane 102b and/or the additional membrane 130.

A second method of forming bipolar membrane composite 100-2m includes imbedding a water dissociation catalyst 146 into an additional membrane 130. A first ion exchange material 144a may be embedded into the open structure 110a and/or the tight structure 120a of the first membrane 102a and a second ion exchange material 144b may be embedded into the open structure 110b and/or the tight structure 120b of the second membrane 102b. Once the membranes have been embedded with the water dissociation catalyst and the ion exchange material, the first membrane, the second membrane, and the additional membrane may be joined using a suitable engagement method.

In a variation of bipolar membrane composite 100-2m, a bipolar membrane composite 100-2n, as seen in FIG. 2N, may include a first membrane 102a and a second membrane 102b each including an open structure 110a, 110b and a tight structure 120a, 120b. The first and second membranes may be joined together such that the open structure 110a, 110b of each of the first and second membranes are coupled to opposing sides of an additional membrane 130. The tight structure 120a of the first membrane 102a and the tight structure 120b of the second membrane 102b may be outwardly facing. Part of the ion exchange material 144a may exceed the volume of the first membrane 102a, forming a buttercoat 148a1, wherein the tight structure 120a is between the buttercoat 148a1 and the open structure 110a. Part of the ion exchange material 144b may exceed the volume of the second membrane 102b, forming a buttercoat 148b1, wherein the tight structure 120b is between the buttercoat 148b1 and the open structure 110b. Similarly, part of the ion exchange material 144a may exceed the volume of the first membrane 102a, forming a buttercoat 148a2, wherein the buttercoat 148a2 is between the additional membrane 130 and the open structure 110a. Part of the ion exchange material 144b may exceed the volume of the first membrane 102b, forming a buttercoat 148b2, wherein the buttercoat 148b2 is between the additional membrane 130 and the open structure 110b.

A first method of forming bipolar membrane composite 100-2n may include embedding a water dissociation catalyst 146 into an additional membrane 130. Once the additional membrane is embedded with the water dissociation catalyst, the first membrane, the second membrane, and the additional membrane may be joined using a suitable engagement method. A first ion exchange material 144a may then be embedded into the tight structure 120a and/or the open structure 110a of the first membrane 102a and/or the additional membrane 130 and a second ion exchange material 144b may be embedded into the tight structure 120b and/or the open structure 110b of the second membrane 102b and/or the additional membrane 130.

A second method of forming bipolar membrane composite 100-2n may include imbedding a water dissociation catalyst 146 into an additional membrane 130. A first ion exchange material 144a may be embedded into the tight structure 120a and/or the open structure 110a of the first membrane 102a and a second ion exchange material 144b may be embedded into the tight structure 120b and/or the open structure 110b of the second membrane 102b. Once the membranes have been embedded with the water dissociation catalyst and the ion exchange material, the first membrane, the second membrane, and the additional membrane may be joined using a suitable engagement method.

In another exemplary embodiment, as seen in FIG. 2O, a bipolar membrane composite 100-2o may include a first membrane 102a and a second membrane 102b. The first membrane 102a may include an open structure 110a and a tight structure 120a. The second membrane 102b may include one of an open structure 110b and a tight structure 120b. The first and second membranes may be joined together such that the tight structure 120a of the first membrane 102a engages one of the open structure 110b and tight structure 120b of the second membrane 102b at an interface 140.

The bipolar membrane composite 100-2o may have a first ion exchange material 144a embedded into at least one of the open structure 110a and the tight structure 120a of the first membrane 102a. A second ion exchange material 144b may be embedded into the one of the open structure 110b and tight structure 120b of the second membrane 102b. A water dissociation catalyst 146 may be embedded into at least one of the tight structure 120a of the first membrane 102a, the open structure 110a of the first membrane 102a, and the open structure 110b/120b of the second membrane 102b. Part of the ion exchange material 144a may exceed the volume of the first membrane 102a, forming a buttercoat 148a1, wherein the open structure 110a is between the buttercoat 148a1 and the tight structure 120a. Part of the ion exchange material 144b may exceed the volume of the second membrane 102b, forming a buttercoat 148b1, wherein one of the open structure 110b and the tight structure 120b is between the buttercoat 148b1 and the tight structure 120a. Similarly, part of the ion exchange material 144a may exceed the volume of the first membrane 102a, forming a buttercoat 148a2, wherein the buttercoat 148a2 is between the tight structure 120a and one of the open structure 110b and the tight structure 120b. Part of the ion exchange material 144b may exceed the volume of the second membrane 102b, forming a buttercoat 148b2, wherein the buttercoat 148b2 is between the tight structure 120a and one of the open structure 110b and the tight structure 120b.

In another exemplary embodiment, as seen in FIG. 2P, a bipolar membrane composite 100-2p may include a first membrane 102a and a second membrane 102b each including an open structure 110a, 110b. The first and second membranes may be joined together such that the open structures 110a, 110b of each of the first and second membranes are coupled to opposing sides of an additional membrane. The additional membrane may be a filled membrane 130.

The bipolar membrane composite 100-2p may have a first ion exchange material 144a embedded into the open structure 110a of the first membrane 102a. A second ion exchange material 144b may be embedded into the open structure 110b of the second membrane 102b. A water dissociation catalyst 146 may be embedded into the additional membrane 120, 130. An ion exchange material 144a, 144b may also be embedded in the additional membrane. Part of the ion exchange material 144a may exceed the volume of the first membrane 102a, forming a buttercoat 148a1, wherein the open structure 110a is between the buttercoat 148a1 and the buttercoat 148a2. Part of the ion exchange material 144b may exceed the volume of the first membrane 102b, forming a buttercoat 148b1, wherein the open structure 110b is between the buttercoat 148b1 and the buttercoat 148b2. Part of the ion exchange material 144a may exceed the volume of the first membrane 102a, forming a buttercoat 148a2, wherein the buttercoat 148a2 is between the additional membrane 130 and the open structure 110a. Part of the ion exchange material 144b may exceed the volume of the first membrane 102b, forming a buttercoat 148b2, wherein the buttercoat 148b2 is between the additional membrane 130 and the open structure 110b.

In another exemplary embodiment, as seen in FIG. 2Q, a bipolar membrane composite 100-2q may include a first membrane 102a and a second membrane 102b. The first membrane 102a may include an open structure 110a. The second membrane 102b may include an open structure 110b. The first and second membranes may be joined together such the open structure 110a of the first membrane 102a engages the open structure 110b of the second membrane 102b at an interface 140.

The bipolar membrane composite 100-2q may have a first ion exchange material 144a embedded into the open structure 110a of the first membrane 102a. A second ion exchange material 144b may be embedded into the open structure 110b of the second membrane 102b. A water dissociation catalyst 146 may be at least partially embedded into at least one of the open structure 110a of the first membrane and the open structure 110b of the second membrane 102b. Part of the ion exchange material 144a may exceed the volume of the first membrane 102a, forming a buttercoat 148a1, wherein the open structure 110a is between the buttercoat 148a1 and the buttercoat 148a2. Part of the ion exchange material 144b may exceed the volume of the first membrane 102b, forming a buttercoat 148b1, wherein the open structure 110b is between the buttercoat 148b1 and the buttercoat 148b2. Similarly, part of the ion exchange material 144a may exceed the volume of the first membrane 102a, forming a buttercoat 148a2, wherein the buttercoat 148a2 is between the interface 140 and the open structure 110a. Part of the ion exchange material 144b may exceed the volume of the first membrane 102b, forming a buttercoat 148b2, wherein the buttercoat 148b2 is between the interface 140 and the open structure 110b.

In another exemplary embodiment, as seen in FIG. 2R, a bipolar membrane composite 100-2r may include a first membrane 102a, a second membrane 102b, and an additional membrane 130. The first membrane 102a may include an open structure 110a and a tight structure 120a. The second membrane 102b may include an open structure 110b. The first and second membranes may be joined together such that the tight structure 120a of the first membrane 102a and the open structure 110b of the second membrane 102b are coupled to opposing sides of the additional membrane 130. The additional membrane 130 may include a tight structure, a filled membrane, or an inert layer, such as a single tight structure, a single open structure, or other microporous polymer structure.

The bipolar membrane composite 100-2r may have a first ion exchange material 144a embedded into the open structure 110a of the first membrane 102a. The first ion exchange material 144a may also be at least partially embedded into the tight structure 120a of the first membrane 102a. A second ion exchange material 144b may be embedded into the open structure 110b of the second membrane 102b. A water dissociation catalyst 146 may be embedded into at least one of the tight structure 120a of the first membrane 102a and the additional membrane 130. An ion exchange material 144a, 144b may also be embedded in the additional membrane. Part of the ion exchange material 144a may exceed the volume of the first membrane 102a, forming a buttercoat 148a1, wherein the open structure 110a is between the buttercoat 148a1 and the tight structure 120a. Part of the ion exchange material 144b may exceed the volume of the first membrane 102b, forming a buttercoat 148b1, wherein the open structure 110b is between the buttercoat 148b1 and the buttercoat 148b2. Part of the ion exchange material 144a may exceed the volume of the first membrane 102a, forming a buttercoat 148a2, wherein the buttercoat 148a2 is between the additional membrane 130 and the tight structure 120a. Part of the ion exchange material 144b may exceed the volume of the first membrane 102b, forming a buttercoat 148b2, wherein the buttercoat 148b2 is between the additional membrane 130 and the open structure 110b.

In another exemplary embodiment, as seen in FIG. 2S, a bipolar membrane 100-2s may include a first membrane 102a, a second membrane 102b, and an additional membrane 130. The first membrane 102a may include an open structure 110. The second membrane 102b may include a tight structure 120. The additional membrane 130 may be between the open structure 110 and the tight structure 120. The additional membrane 130 may include a tight structure, a filled membrane, or an inert layer, such as a single tight structure, a single open structure, or other microporous polymer structure.

The bipolar membrane 100-2s may have a first ion exchange material 144a embedded into the open structure 110 and a second ion exchange material 144b embedded into the tight structure 120. At least one of the first ion exchange material 144a and the second ion exchange material 144b may be at least partially embedded into the additional membrane 130. A water dissociation catalyst 146 may be at least partially embedded into the additional membrane 130 of membrane 100-2i. Part of the ion exchange material 144a may exceed the volume of the first membrane 102a, forming a buttercoat 148a1, wherein the open structure 110 is between the buttercoat 148a1 and the buttercoat 148a2. Part of the ion exchange material 144b may exceed the volume of the first membrane 102b, forming a buttercoat 148b1, wherein the tight structure 120 is between the buttercoat 148b1 and the buttercoat 148b2. Part of the ion exchange material 144a may exceed the volume of the first membrane 102a, forming a buttercoat 148a2, wherein the buttercoat 148a2 is between the additional membrane 130 and the open structure 110. Part of the ion exchange material 144b may exceed the volume of the first membrane 102b, forming a buttercoat 148b2, wherein the buttercoat 148b2 is between the additional membrane 130 and the tight structure 120.

In another exemplary embodiment, as seen in FIG. 2T, a bipolar membrane 100-2t may include a first membrane 102a, a second membrane 102b, and an additional membrane 130. The first membrane 102a may include an open structure 110 and a tight structure 120a. The second membrane 102b may include a tight structure 120b. The first and second membranes may be joined together such that the tight structure 120a of the first membrane 102a and the tight structure 120b of the second membrane 102b are coupled to opposing sides of the additional membrane 130. The additional membrane 130 may include a tight structure, a filled membrane, or an inert layer, such as a single tight structure, a single open structure, or other microporous polymer structure.

The bipolar membrane 100-2t may have a first ion exchange material 144a embedded into the open structure 110 of the first membrane 102a. The first ion exchange material 144a may also be at least partially embedded into the tight structure 120a of the first membrane 102a. A second ion exchange material 144b embedded into the tight structure 120b. At least one of the first ion exchange material 144a and the second ion exchange material 144b may be at least partially embedded into the additional membrane 130. A water dissociation catalyst 146 may be at least partially embedded into the additional membrane 130 of membrane 100-2j. Part of the ion exchange material 144a may exceed the volume of the first membrane 102a, forming a buttercoat 148a1, wherein the open structure 110a is between the buttercoat 148a1 and the tight structure 120a. Part of the ion exchange material 144b may exceed the volume of the first membrane 102b, forming a buttercoat 148b1, wherein the tight structure 120b is between the buttercoat 148b1 and the buttercoat 148b2. Similarly, part of the ion exchange material 144a may exceed the volume of the first membrane 102a, forming a buttercoat 148a2, wherein the buttercoat 148a2 is between the additional membrane 130 and the tight structure 120a. Part of the ion exchange material 144b may exceed the volume of the first membrane 102b, forming a buttercoat 148b2, wherein the buttercoat 148b2 is between the additional membrane 130 and the tight structure 120b.

For any of the preceding embodiments, the reinforcement layer of the AEL may include a plurality of pores having an average pore size of about 0.05 μm to about 1.0 μm, such as about 0.05 μm, about 0.1 μm, about 0.15 μm, about 0.2 μm, about 0.25 μm, about 0.3 μm, about 0.35 μm, about 0.4 μm, about 0.45 μm, about 0.5 μm, about 0.55 μm, about 0.6 μm, about 0.65 μm, about 0.7 μm, about 0.75 μm, about 0.8 μm, about 0.85 μm, about 0.9 μm, about 0.95 μm, or about 1.0 μm. The average pore size may also be in ranges such as about 0.05 μm to about 1.0 μm, about 0.1 μm to about 0.9 μm, about 0.2 μm to about 0.8 μm, about 0.3 μm to about 0.7 μm, about 0.15 μm to about 0.95 μm, about 0.25 μm to about 0.85 μm, or about 0.4 μm to about 0.6 μm. The porosity of the AEL reinforcement layer may be about 50% to about 90% by volume, such as about 50%, about 55%, about 60%, about 65%, about 70%, about 75%, about 80%, about 85%, or about 90% by volume. The porosity may also be in ranges such as about 50% to about 90%, about 55% to about 85%, about 60% to about 80%, about 65% to about 75%, about 52% to about 88%, about 58% to about 82%, or about 62% to about 78% by volume.

For any of the preceding embodiments, the reinforcement layer of the CEL may include a plurality of pores having an average pore size of about 0.05 μm to about 1.0 μm, such as about 0.05 μm, about 0.1 μm, about 0.15 μm, about 0.2 μm, about 0.25 μm, about 0.3 μm, about 0.35 μm, about 0.4 μm, about 0.45 μm, about 0.5 μm, about 0.55 μm, about 0.6 μm, about 0.65 μm, about 0.7 μm, about 0.75 μm, about 0.8 μm, about 0.85 μm, about 0.9 μm, about 0.95 μm, or about 1.0 μm. The average pore size may also be in ranges such as about 0.05 μm to about 1.0 μm, about 0.1 μm to about 0.9 μm, about 0.2 μm to about 0.8 μm, about 0.3 μm to about 0.7 μm, about 0.15 μm to about 0.95 μm, about 0.25 μm to about 0.85 μm, or about 0.4 μm to about 0.6 μm. The porosity of the CEL reinforcement layer may be about 50% to about 90% by volume, such as about 50%, about 55%, about 60%, about 65%, about 70%, about 75%, about 80%, about 85%, or about 90% by volume. The porosity may also be in ranges such as about 50% to about 90%, about 55% to about 85%, about 60% to about 80%, about 65% to about 75%, about 52% to about 88%, about 58% to about 82%, or about 62% to about 78% by volume.

For any of the preceding embodiments, the reinforcement layer of the AEL may be configured to balance the mechanical properties of the anion exchange polymer, while the reinforcement layer of the CEL may be configured to balance the mechanical properties of the cation exchange polymer. This balancing may reduce interfacial strain between the AEL and CEL during operation of the bipolar membrane composite. The interfacial strain of each of the reinforcement layers of the AEL and CEL may be independently controlled to be from about 0.1% to about 5%, i.e., about 0.1%, about 0.5%, about 1%, about 1.5%, about 2%, about 2.5%, about 3%, about 3.5%, about 4%, or about 5%. For example, the interfacial strain may be from about 0.1% to about 4.5%, from about 0.5% to about 2.5%, from about 1% to about 5%, from about 3.5% to about 5%, or from about 0.1% to about 2.5%.

For any of the preceding embodiments, the balanced mechanical properties may include elastic moduli in the x-y direction. The elastic moduli in the x-y direction of each of the reinforcement layers of the AEL and CEL may be independently selected from about 10 MPa to about 500 MPa, i.e., about 10 MPa, about 25 MPa, about 50 MPa, about 75 MPa, about 100 MPa, about 125 MPa, about 150 MPa, about 175 MPa, about 200 MPa, about 225 MPa, about 250 MPa, about 275 MPa, about 300 MPa, about 325 MPa, about 350 MPa, about 375 MPa, about 400 MPa, about 425 MPa, about 450 MPa, about 475 MPa, or about 500 MPa. For example, the elastic moduli may be from about 10 MPa to about 500 MPa, about 50 MPa to about 450 MPa, about 100 MPa to about 400 MPa, about 150 MPa to about 350 MPa, about 200 MPa to about 300 MPa, about 75 MPa to about 475 MPa, about 125 MPa to about 375 MPa, or about 175 MPa to about 425 MPa.

For any of the preceding embodiments, the AEL and CEL may have balanced hydration levels that provide balanced swelling and prevent dimensional mismatch during operation. The hydration levels of the AEL and CEL may each be independently controlled to be from about 5% to about 50%, i.e., about 5%, about 7%, about 10%, about 12%, about 15%, about 17%, about 20%, about 22%, about 25%, about 27%, about 30%, about 32%, about 35%, about 37%, about 40%, about 42%, about 45%, about 47%, or about 50%. For example, the hydration levels may be from about 5% to about 50%, about 7% to about 45%, about 10% to about 40%, about 12% to about 35%, about 15% to about 30%, about 8% to about 48%, about 18% to about 42%, or about 20% to about 35%. This balanced hydration may prevent excessive dimensional changes that could compromise the integrity of the bipolar membrane composite.

For any of the preceding embodiments, the reinforcement layer of the AEL or CEL may be positioned to prevent curl of the bipolar membrane composite.

For any of the preceding embodiments, the ratio of the reinforcement layer of the AEL or CEL to the total layer thickness of the AEL or CEL may be selected such that curl is controlled. This ratio may be optimized based on the specific materials and processing conditions used.

For any of the preceding embodiments, the reinforcement layer of the CEL may be positioned relative to the reinforcement layer of the AEL to balance dimensional stability. The centerlines of both reinforcement layers may be aligned within ±1 millimeter across the membrane thickness, such as within. The thicknesses of both reinforcement layers may differ by no more than 30%, i.e., no more than about 5%, about 10%, about 15%, about 20%, about 25%, or about 30%. The difference in thickness may also be from about 5% to about 30%, about 10% to about 25%, about 15% to about 20%, about 8% to about 28%, about 12% to about 22%, or about 18% to about 25%.

For any of the preceding embodiments, the ratio of the anion exchange polymer to the reinforcement layer of the AEL may be configured to balance the dimensional stability properties of the CEL. The AEL reinforcement layer may be from about 10% to about 100% of the anion exchange polymer, i.e., about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100%. For example, from about 10% to about 100%, about 20% to about 90%, about 30% to about 80%, about 40% to about 70%, about 50% to about 60%, about 15% to about 95%, about 25% to about 85%, or about 35% to about 75%. The specific ratio may be optimized based on the desired performance characteristics and the materials used in the bipolar membrane composite.

For any of the preceding embodiments, the water dissociation catalyst may be embedded within a reinforced catalyst layer having a pore size and shape that matches the pore size and shape of the catalyst particles. This matching may optimize the distribution and accessibility of the catalyst within the membrane structure. The reinforced catalyst layer may include a microporous structure that provides mechanical support for the water dissociation catalyst, preventing catalyst migration or agglomeration during operation.

For any of the preceding embodiments, the microporous structure of the reinforced catalyst layer may have pore characteristics selected to enhance water transport to the water dissociation catalyst. These pore characteristics may include an average pore size from about 0.05 μm to about 1.0 μm, such as about 0.05 μm, about 0.1 μm, about 0.2 μm, about 0.3 μm, about 0.4 μm, about 0.5 μm, about 0.6 μm, about 0.7 μm, about 0.8 μm, about 0.9 μm, or about 1.0 μm. The porosity may be from about 50% to about 90% by volume, such as about 50%, about 55%, about 60%, about 65%, about 70%, about 75%, about 80%, about 85%, or about 90% by volume.

For any of the preceding embodiments, both the reinforcement layer of the AEL and the reinforcement layer of the CEL may be positioned to control swelling behavior and dimensional stability. This positioning may help maintain the structural integrity of the bipolar membrane composite during hydration and operation.

For any of the preceding embodiments, the total swelling of the bipolar membrane composite upon hydration is about 10% to about 45%, i.e., about 10%, about 12%, about 15%, about 18%, about 20%, about 22%, about 25%, about 28%, about 30%, about 32%, about 35%, about 38%, about 40%, about 42%, or about 45%. The total swelling may be from about 10% to about 45%, about 12% to about 42%, about 15% to about 40%, about 18% to about 38%, about 20% to about 35%, about 22% to about 32%, about 25% to about 30%, about 14% to about 44%, about 16% to about 36%, or about 28% to about 43%. This controlled swelling may prevent delamination or other structural failures. The total swelling referred to herein refers to the volumetric increase of the bipolar membrane composite upon hydration.

For any of the preceding embodiments, the anion exchange polymer and cation exchange polymer may include chemical backbones that are substantially similar to each other. The structural similarity may be achieved by selecting polymers with similar backbone chemistries, such as perfluorinated backbones or hydrocarbon backbones, while maintaining different functional groups for anion and cation exchange properties.

### III. Electrolysis Method

The present disclosure provides a method of separating a main flow of fluid into an acidic solution and a basic solution using a bipolar membrane composite. Each acidic solution and basic solution may be separated into a first flow and a second flow. The fluid may be water, salt water, an electrolyte solution, or other solution including ions. An acid solution may be a fluid with a high concentration of protons. The acidic solution may have a pH of −1, 0, 1, 2, 3, 4, 5, 6, or 7 or any range including the foregoing values as endpoints, such as −1 to 7, 0 to 6, 1 to 5, 2 to 4. The acidic solution may be defined as the flow with a higher concentration of protons than the basified flow.

A basic solution may include a fluid with a high concentration of hydroxide ions. The basic solution may have a pH of 7, 8, 9, 10, 11, 12, 13, 14, or 15 or any range including the foregoing values as endpoints, such as 7 to 15, 8 to 14, 9 to 13, or 10 to 12. The basic solution may be defined as the flow with a higher concentration of hydroxide ions than the acidic solution.

To create the acidic solution and the basic solution, a current may be applied to the bipolar membrane composite in an electro-dialyzing apparatus of the present disclosure. The bipolar membrane composite may be hydrated with a fluid, such as water, salt water, seawater, or electrolyte solution. The electric current may flow across the bipolar membrane allowing dissociation of the fluid's molecules and to separate ions, such as protons and hydroxide ions, within the fluid to create an acidic solution and a basic solution. A first side of the bipolar membrane composite facing the first flow and the second flow may be disposed proximate to an opposing second side of the bipolar membrane composite facing the second flow.

In one embodiment, the bipolar membrane composite used to create the acidic solution and basic solution includes a first and second membrane. The first flow faces the first membrane with an ion exchange material embedded into at least one of the open structure or tight structure of the first membrane. The ion exchange material embedded in the first membrane may be a cation exchange material. Further, in this embodiment, the second solution faces the second membrane with an ion exchange material embedded into at least one of the open structure or tight structure of the second membrane. The ion exchange material embedded in the second membrane may be an anion exchange material.

As the main flow hydrates the membranes from both sides, water from the flow of fluid is dissociated at the catalyst layer. The electric current draws cations into a first flow on the first side with the cation exchange material to create the acid solution. The electric current draws anions into a second flow on the second side with the anion exchange material to create the basic solution.

The acid solution and the basic solution may be used in other processes. Processes that may use the acidified and basified flows include carbon dioxide removal carbon capture, carbon dioxide reduction, sodium sulfate remediation, metal recovery, and reduction of N₂ to ammonia.

### IV. Electrodialysis System

The disclosure further provides an electrodialysis system for separating a flow of fluid into an acid solution and a basic solution using the method previously described.

The electrodialysis system may include a bipolar membrane, such as any of the bipolar membrane composites previously described and shown in FIGS. 1A-1L, a fluid, a first electrode, and a second electrode.

The first electrode may be an anode and the second electrode may be a cathode.

The first and second electrodes may provide a charge across the bipolar membrane composite such that when the bipolar membrane composite is hydrated with a fluid, such as water, salt water, seawater, or an electrolyte fluid, an oxidation-reduction reaction occurs, dissociating water from the fluid into a proton component and a hydroxide ion component. Each component may be drawn into a fluid flow, creating an acidic solution including the proton ions, and a basic solution including the hydroxide ions. Each flow may be disposed on opposing sides of the bipolar membrane composite.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

1. A bipolar membrane composite that generates an acidic solution and a basic solution when the membrane composite is exposed to water and an electric current by enabling an oxidation-reduction reaction that dissociates water into a proton component and a hydroxide ion component with each component disposed on opposing sides of the bipolar membrane composite, the bipolar membrane composite comprising:
an anion exchange layer (AEL) comprising an anion exchange polymer and optionally an AEL reinforcement layer at least partially embedded within the anion exchange polymer;
a cation exchange layer (CEL) comprising a cation exchange polymer and optionally a CEL reinforcement layer at least partially embedded within the cation exchange polymer;
wherein at least one of the AEL or CEL has a reinforcement layer having an open structure, defining a plurality of pores having an average pore size of 0.05 μm to 5.0 μm;
a water dissociation catalyst at least partially embedded within at least one of the AEL or CEL such that the water dissociation catalyst is embedded extending from an interface between the AEL and CEL into less than 10% of a thickness of the at least one of the AEL or CEL.

2. A method of creating an acidic flow and a basic flow from a main flow of water, the method comprising:
applying an electric current to a bipolar membrane composite in an electrochemical apparatus;
wherein the bipolar membrane composite includes:
an anion exchange layer (AEL) comprising an anion exchange polymer and optionally a AEL reinforcement layer at least partially embedded within the anion exchange polymer;
a cation exchange layer (CEL) comprising a cation exchange polymer and optionally a CEL reinforcement layer at least partially embedded within the cation exchange polymer;
wherein at least one of the AEL or CEL has a reinforcement layer having an open structure, defining a plurality of pores having an average pore size of 0.05 μm to 5.0 μm;
a water dissociation catalyst at least partially embedded within at least one of the AEL or CEL such that the water dissociation catalyst is embedded extending from an interface between the AEL and CEL into less than 10% of a thickness of the at least one of the AEL or CEL;
hydrating the bipolar membrane composite with water,
dissociating water at the water dissociation catalyst; and
separating the protons into a first flow and hydroxide ions into a second flow, the first flow disposed proximate to a first side of the bipolar membrane composite facing the first flow, the second flow disposed proximate to an opposing second side of the bipolar membrane composite facing the second flow;
wherein the CEL faces the first flow and the AEL faces the second flow;
wherein the first flow includes the acidic flow and the second flow includes the basic flow.

3. An electrodialysis system, comprising:
the bipolar membrane composite of claim 1;
a fluid;
a first electrode, the first electrode comprising an anode; and
a second electrode, the second electrode comprising a cathode.

4. The bipolar membrane composite of claim 1, wherein the AEL has a thickness of 1-30 μm and the AEL reinforcement layer has a thickness of 1-5 μm, and wherein the CEL has a thickness of 1-60 μm and the CEL reinforcement layer has a thickness of 1-10 μm.

5. The bipolar membrane composite of claim 1, wherein the AEL reinforcement layer is about 1 to about 60% of the AEL, or wherein the CEL reinforcement layer is about 1% to about 60% of the CEL.

6. The bipolar membrane composite of claim 1, further comprising a catalyst layer, optionally wherein the catalyst layer comprises a reinforcement layer, wherein the reinforcement layer may be intrinsic to the reinforcement layer of the AEL or CEL or an independent reinforcement layer.

7. The bipolar membrane composite of claim 1, wherein part of the anion exchange polymer may exceed the volume of the AEL, or wherein part of the cation exchange polymer may exceed the volume of the CEL.

8. The bipolar membrane composite of claim 1, wherein the reinforcement layer of the AEL comprises pore characteristics configured to enhance transport of hydroxide ions, and wherein the reinforcement layer of the AEL comprises a plurality of pores having an average pore size of 0.05 μm to 1.0 μm and a porosity of about 50% to about 90% by volume, or wherein the reinforcement layer of the CEL comprises pore characteristics configured to enhance transport of protons, and wherein the reinforcement layer of the CEL comprises a plurality of pores having an average pore size of 0.05 μm to 1.0 μm and a porosity of about 50% to about 90% by volume.

9. The bipolar membrane composite of claim 1, wherein the reinforcement layer of the AEL is configured to balance the mechanical properties of the anion exchange polymer and the reinforcement layer of the CEL is configured to balance the mechanical properties of the cation exchange polymer to reduce interfacial strain, and wherein the interfacial strain of each of the reinforcement layers of the AEL and CEL is independently from about 0.1% to about 5%.

10. The bipolar membrane composite of claim 9, wherein the balanced mechanical properties comprise elastic moduli in the x-y direction, and wherein the elastic moduli in the x-y direction of each of the reinforcement layers of the AEL and CEL is independently from about 10 MPA to about 500 MPa.

11. The bipolar membrane composite of claim 1, wherein the AEL and CEL have balanced hydration levels that provide balanced swelling and prevent dimensional mismatch, and wherein the hydration levels of the AEL and CEL are each independently from about 5% to about 50%.

12. The bipolar membrane composite of claim 1, wherein the reinforcement layer of the AEL or CEL is positioned to prevent curl of the bipolar membrane composite, and optionally wherein the ratio of the reinforcement layer of the AEL or CEL to the total layer thickness of the AEL or CEL is selected such that the curl is controlled.

13. The bipolar membrane composite of claim 1, wherein the reinforcement layer of the CEL is positioned relative to the reinforcement layer of the AEL to balance dimensional stability.

14. The bipolar membrane composite of claim 1, wherein a ratio of the anion exchange polymer to the reinforcement layer of the AEL is configured to balance the dimensional stability properties of the CEL, and wherein the AEL reinforcement layer is from about 10% to about 100% of the anion exchange polymer.

15. The bipolar membrane composite of claim 1, wherein the reinforced catalyst layer comprises a microporous structure that provides mechanical support for the water dissociation catalyst.

16. The bipolar membrane composite of claim 15, wherein the water dissociation catalyst is embedded within a reinforced catalyst layer having a pore size and shape that matches the pore size and shape of the catalyst particles.

17. The bipolar membrane composite of claim 15, wherein the microporous structure of the reinforced catalyst layer has pore characteristics selected to enhance water transport to the water dissociation catalyst, and wherein the pore characteristics comprise an average pore size from about 0.05 μm to about 1.0 μm and a porosity from about 50% to about 90% by volume.

18. The bipolar membrane composite of claim 1, wherein both the reinforcement layer of the AEL and the reinforcement layer of the CEL are positioned to control swelling behavior and dimensional stability.

19. The bipolar membrane composite of claim 18, wherein the total swelling of the bipolar membrane composite upon hydration is about 10% to about 45%, wherein the total swelling refers to the volumetric increase of the bipolar membrane composite.

20. The bipolar membrane composite of claim 1, wherein the anion exchange polymer and cation exchange polymers comprise chemical backbones that are substantially similar to each other.
